(19) United States
(12) Patent Application Publication
(10) Pub. No.: US 2024/0322966 A1
(43) Pub. Date: Sep. 26, 2024

(54) CHANNEL STATE INFORMATION (CSI) PRIORITY AND MULTIPLEXING FOR APERIODIC CSI REPORTING

(71) Applicant: QUALCOMM Incorporated, San Diego, CA (US)

(72) Inventors: Ahmed ELSHAFIE, San Diego, CA (US); Alexandros MANOLAKOS, Athens, Attikí (GR); Kianoush HOSSEINI, San Diego, CA (US)

(21) Appl. No.: 18/580,404

(22) PCT Filed: Aug. 22, 2022
(86) PCT No.: PCT/US2022/075281

§ 371 Date: Jan. 18, 2024

(30) Foreign Application Priority Data
Sep. 15, 2021 (GR) 20210100612

(51) Int. Cl. H04L 5/00; H04W 24/08; H04W 72/23

(52) U.S. Cl. CPC H04L 5/0048; H04W 24/08; H04W 72/23

(57) ABSTRACT

The present disclosure provides systems, methods and apparatus, including computer programs encoded on computer storage media, for channel state information (CSI) priority and multiplexing for aperiodic CSI reporting between a user equipment (UE) and a base station. The UE may receive a CSI report configuration that configures the UE to transmit a first CSI report associated with a first CSI reference signal (CSI-RS) implicitly triggered by a downlink control signal, a second CSI report associated with a second CSI-RS, or a third CSI report associated with a downlink data signal. The UE may determine that the first CSI report is scheduled to transmit on a same uplink resource as the second CSI report or the third CSI report. The UE may transmit a plurality of the first CSI report, the second CSI report or the third CSI report multiplexed on the same uplink resource based on a report prioritization.

### CROSS REFERENCE TO RELATED APPLICATION(S)

This application claims the benefit of Greece Patent Application Ser. No. 20210100612, entitled “CHANNEL STATE INFORMATION (CSI) PRIORITY AND MULTIPLEXING FOR APERIODIC CSI REPORTING” and filed on Sep. 15, 2021, which is expressly incorporated by reference herein in its entirety.

### BACKGROUND

### Technical Field

The present disclosure generally relates to communication systems, and more particularly, to channel state information (CSI) priority and multiplexing for aperiodic CSI reporting.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE may receive, from a base station, via the transceiver, a channel state information (CSI) report configuration that configures the UE to transmit a first CSI report associated with a first CSI reference signal (CSI-RS) that is implicitly triggered by a downlink control signal, a second CSI report associated with a second CSI-RS, or a third CSI report associated with a downlink data signal. The UE may determine that the first CSI report associated with the first CSI-RS that is implicitly triggered by the downlink control signal is scheduled to be transmitted on a same uplink resource as one or more of the second CSI report associated with the second CSI-RS or the third CSI report associated with the downlink data signal. The UE may transmit, via the transceiver, a plurality of the first CSI report, the second CSI report or the third CSI report multiplexed on the same uplink resource based on a report prioritization.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame.

FIG. 2B is a diagram illustrating an example of DL channels within a subframe.

FIG. 2C is a diagram illustrating an example of a second frame.

FIG. 2D is a diagram illustrating an example of a subframe.

FIG. 3 is a diagram illustrating an example of a base station (BS) and user equipment (UE) in an access network.

FIG. 4 is a diagram illustrating an example of a UE transmission of an aperiodic CSI report on a physical uplink shared channel (PUSCH) in response to an uplink grant from a base station.

FIG. 5 is a diagram illustrating an example of partial CSI omission for PUSCH-based CSI reporting.

FIG. 6 is a diagram illustrating an example transmission of an aperiodic CSI report in response to a downlink grant.

FIG. 7 is a diagram illustrating example downlink control information signaling for activation and deactivation of CSI reporting based on a semi-persistent scheduling configuration.

FIG. 8 is a diagram illustrating example transmissions of an aperiodic CSI report in response to a downlink grant.

FIG. 9 illustrates an example of a two-stage UCI for reporting CSI feedback.

FIG. 10 is a diagram illustrating example transmissions of an aperiodic CSI report in response to a downlink grant.

FIG. 11 is a diagram illustrating example communications and components of a base station and a UE.

FIG. 12 is a conceptual data flow diagram illustrating the data flow between different means/components in an example base station.

FIG. 13 is a conceptual data flow diagram illustrating the data flow between different means/components in an example UE.

FIG. 14 is a flowchart of an example method 1400 for a UE report CSI based on an aperiodic CSI.

FIG. 15 is a flowchart of an example method for a base station to receive an aperiodic CSI report or a downlink grant based CSI report.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or Internet-of-things (IoT) network, such as a system utilizing 3G, 4G or 5G, or further implementations thereof, technology.

A user equipment (UE) may transmit a channel state information (CSI) report to inform a base station about channel conditions. Conventionally, the UE determines the CSI based on a CSI reference signal (CSI-RS) transmitted by the base station and transmits the CSI report on either a physical uplink control channel (PUCCH) or a physical uplink shared channel (PUSCH). When a UE communicates with a base station over a wireless channel, the UE may measure channel quality and report channel quality measurement results to the base station. For example, the base station may transmit one or more CSI-RS to the UE, and the UE may measure a signal-to-noise ratio (SNR) (or signal to noise interference ratio (SINR)) of the channel based on a reference signal received power (RSRP) or received signal strength indicator (RSSI) of the CSI-RS. Here, SNR and SINR are referred to interchangeably, and thus any reference to SNR may be substituted with SINR or vice-versa throughout this disclosure. The UE may also measure SINR or perform other channel quality measurements based on other signals than CSI-RS, such as demodulation reference signals (DMRS) or other signals on a physical downlink shared channel (PDSCH) that may assist the UE in decoding the PDSCH. The UE may then identify CSI based on the measured RSRP/RSSI/SINR and provide a CSI report to the base station including one or more reporting parameters indicating the channel quality measurement results. For example, the UE may report a channel quality indicator (CQI), a precoding matrix indicator (PMI), a rank indicator (RI), a layer indicator (LI), or other types of CSI (e.g. L1-RSRP, etc.) based on the CSI-RS, DMRS, or other PDSCH signals.

The UE may be configured to transmit a periodic CSI, an aperiodic CSI and/or a semi-persistent CSI. In this regard, the base station may schedule the UE to provide CSI reports to the base station periodically, semi-persistently, or aperiodically. For example, the base station may transmit a RRC configuration to the UE scheduling periodic CSI-RS transmissions and CSI feedback on PUCCH. In another example, the base station may transmit to the UE a MAC-CE or DCI that triggers semi-persistently scheduled CSI-RS transmissions and CSI feedback. The UE may provide the semi-persistent CSI feedback on PUCCH in response to a MAC-CE or on PUSCH in response to a DCI.

For the aperiodic CSI, the base station may transmit an uplink grant that provides the PUSCH resource for the CSI report. For example, the base station may transmit an uplink grant to the UE (e.g. a DCI scheduling a PUSCH transmission), which triggers aperiodic CSI-RS transmissions and CSI feedback. The UE may provide the aperiodic CSI feedback on PUSCH in response to the DCI. In other aspects, for the aperiodic CSI, the base station may transmit a downlink grant, which may trigger the UE to obtain a CSI report in response to the PDSCH associated with the downlink grant.

The base station may transmit a downlink grant to the UE (e.g. downlink control information (DCI) scheduling a PDSCH transmission), which triggers aperiodic CSI-RS transmissions and CSI feedback. For example, the base station may provide DCI including a CSI trigger field, and the UE may measure CSI and transmit the aperiodic CSI report in response to the DCI. The UE may provide the aperiodic CSI feedback on PUCCH in response to the DCI, as well as HARQ-ACK feedback on PUCCH in response to downlink data scheduled by the DCI. In response to the CSI report, the base station may adjust MCS or other parameters to result in more reliable or faster, subsequent downlink transmissions. Thus, downlink grant-triggered, aperiodic CSI reporting may support reduced latency and increased reliability in communications.

Accordingly, to improve efficiency in CSI reporting, especially for ultra-reliable low latency communication (URLLC) or other high reliability services, the base station may schedule the UE to transmit an aperiodic CSI report (A-CSI) on PUSCH using the UL grant. In other 5G NR approaches, the base station may issue the DL grant to trigger the UE to transmit an aperiodic CSI report on PUCCH. This particular approach using PUCCH may enable faster A-CSI reporting than A-CSI reporting on PUSCH. For instance, the A-CSI reporting on PUCCH may provide the base station with more up-to-date CSI information, which in turn can improve PDSCH performance.

In an aspect, the present disclosure provides for CSI priority and multiplexing for aperiodic CSI reporting. In some aspects, the UE may be scheduled to report multiple CSI reports, where the UE may be configured to measure CSI-RS on aperiodic, periodic or semi-persistent resources or through the innovative mechanism described above where the RRC configuration and/or the MAC CE-based triggering procedure may configure a window of time in which a CSI-RS resource can be triggered with any DL DCI or certain semi-persistent scheduling (SPS) index DCI. In this regard, there may be at least two sources for scheduling A-CSI reporting. In one configuration, there may be multiple CSI reports from two or more different sets of CSI-RS resources, in which one or more sets of CSI-RS resources are associated with periodic or semi-persistent CSI-RS and the other set of CSI-RS resources is associated with the implicit DL DCI triggering. With this new A-CSI reporting, which is triggered implicitly by the DL DCI, innovative prioritization and multiplexing rules may be implemented.

Particular implementations of the subject matter described in this disclosure can be implemented to realize one or more of the following potential advantages. A UE may prioritize and multiplex CSI reporting to increase flexibility in CSI reporting and reduce delay in adapting to changing channel conditions. For example, when the base station schedules the UE to transmit multiple CSI reports on a same uplink resource, the UE may multiplex the multiple CSI reports and/or prioritize between a DL DCI implicitly-triggered A-CSI, periodic/aperiodic/semi-persistent CSI-RS resources, or a PDSCH-based CSI report.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

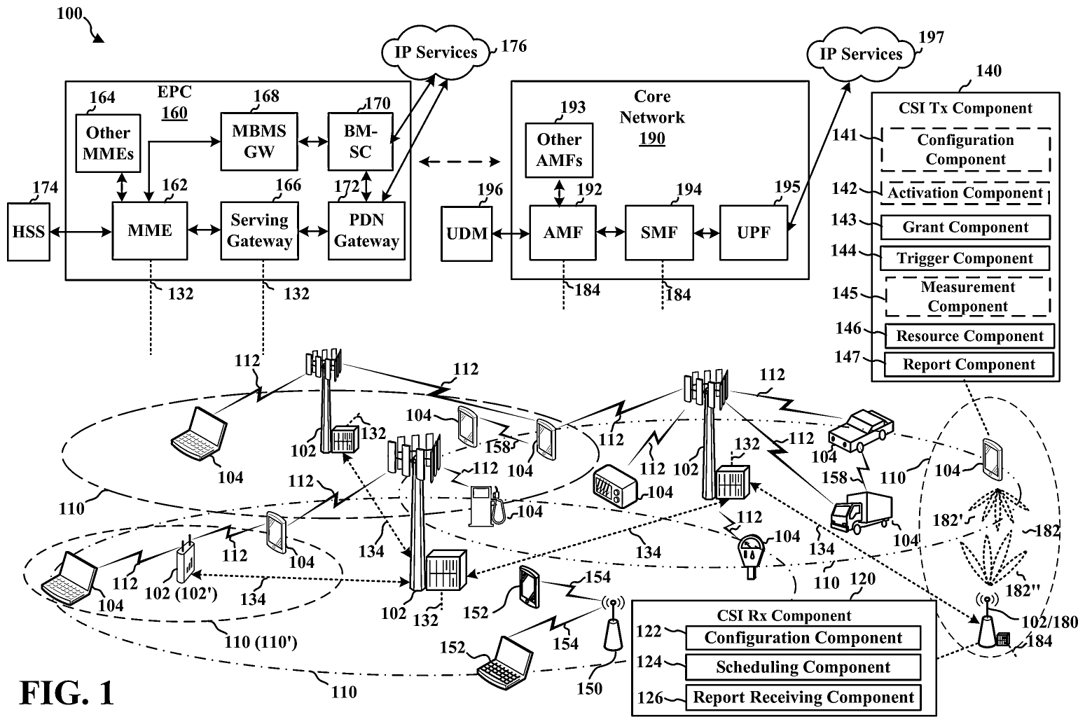

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (such as a 5G Core (5GC)). The base stations 102 may include macrocells (high power cellular base station) or small cells (low power cellular base station). The macrocells include base stations. The small cells include femtocells, picocells, and microcells.

In some implementations, one or more of the UEs 104 may include a CSI transmit (Tx) component 140 that transmits a CSI report using CSI priority and multiplexing for aperiodic CSI reporting. The CSI Tx component 140 may include a grant component 143 that is configured to receive a downlink grant scheduling a PDSCH, a trigger component 144 that is configured to determine that a first CSI report associated with the first CSI-RS that is implicitly triggered by a downlink control signal (e.g., DCI) is scheduled to be transmitted on a same uplink resource as one or more of a second CSI report associated with the second CSI-RS or a third CSI report associated with the downlink data signal, a resource component 146 configured to determine a reserved uplink resource on which to report the CSI, and a report component 147 configured to transmit one or more CSI reports multiplexed on the reserved uplink resource. The CSI Tx component 140 may optionally include a configuration component 141 that is configured to receive a CSI report configuration that configures the UE 104 to transmit a first CSI report associated with a first CSI-RS that is implicitly triggered by a downlink control signal, a second CSI report associated with a second CSI-RS, or a third CSI report associated with a downlink data signal. The CSI Tx component 140 may optionally include an activation component 142 configured to receive a command that activates a measurement window having a predetermined length that corresponds to when the UE expects to receive the one or more second CSI-RS resources after receiving the downlink control signal. The CSI Tx component 140 may optionally include a measurement component 145 configured to perform channel measurements and determine the CSI based on the CSI-RS, the CSI-RS implicitly triggered by DL DCI, or the PDSCH.

In some implementations, one or more of the base stations 102 may include a CSI receive (Rx) component 120 that receives a plurality of the first CSI report, the second CSI report or the third CSI report multiplexed on the same uplink resource based on a report prioritization. The CSI Rx component 120 may include configuration component 122, a scheduling component 124, and a report receiving component 126. The configuration component 122 may be configured to configure a UE with a CSI report configuration that configures the UE 102 to transmit a first CSI report associated with a first CSI-RS that is implicitly triggered by a downlink control signal, a second CSI report associated with a second CSI-RS, or a third CSI report associated with a downlink data signal. The scheduling component 124 may be configured to transmit a downlink grant that schedules a PDSCH. The report receiving component 126 may be configured to receive the plurality of the first CSI report, the second CSI report or the third CSI report multiplexed on the same uplink resource.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (such as SI interface), which may be wired or wireless. The base stations 102 configured for 5G NR (collectively referred to as Next Generation RAN (NG-RAN)) may interface with core network 190 through second backhaul links 184, which may be wired or wireless. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or core network 190) with each other over third backhaul links 134 (such as X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (cNBs) (HeNBs), which may provide service to a restricted group known as a closed subscriber group (CSG). The communication links 112 between the base stations 102 and the UEs 104 may include uplink (UL) (also referred to as reverse link) transmissions from a UE 104 to a base station 102 or downlink (DL) (also referred to as forward link) transmissions from a base station 102 to a UE 104. The communication links 112 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as macro base station), may include an eNB, gNodeB (gNB), or other type of base station. Some base stations, such as gNB 180 may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHZ-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHZ-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a packet-switched (PS) Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as a MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 5G NR, the concepts described herein may be applicable to other similar areas, such as LTE, LTE-A, CDMA, GSM, and other wireless technologies including future 6G technologies.

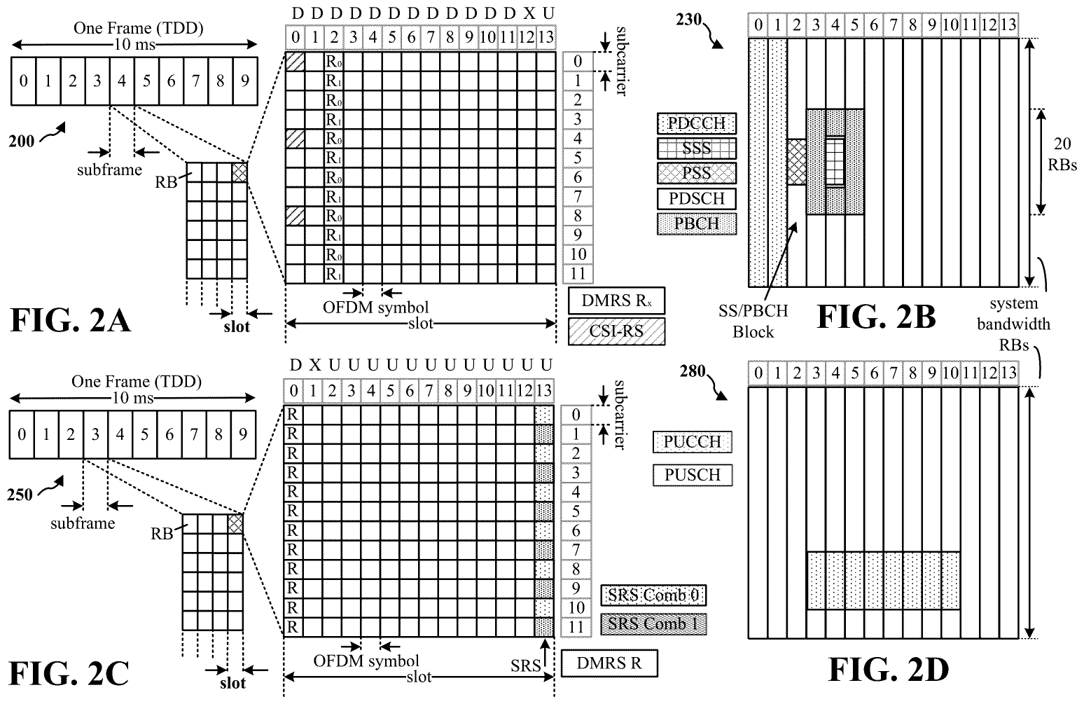

FIG. 2A is a diagram 200 illustrating an example of a first frame. FIG. 2B is a diagram 230 illustrating an example of DL channels within a subframe. FIG. 2C is a diagram 250 illustrating an example of a second frame. FIG. 2D is a diagram 280 illustrating an example of a subframe. The 5G/NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure or different channels. A frame (10 milliseconds (ms)) may be divided into 10 equally sized subframes (1 ms). Each subframe may include one or more time slots. Subframes also may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS also may include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

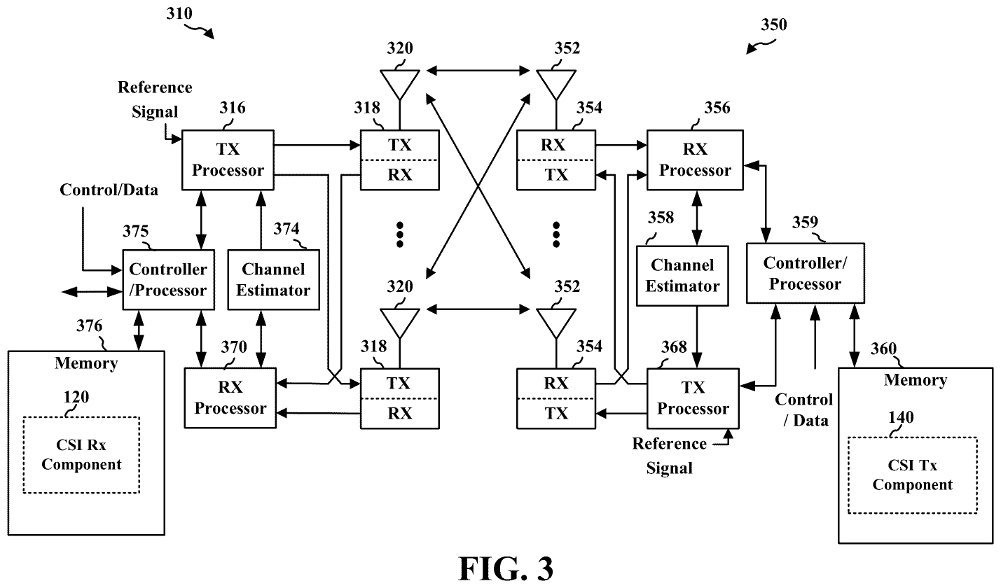

FIG. 3 is a diagram of an example of a base station 310 and a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (such as a pilot) in the time or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 350. Each spatial stream may then be provided to a different antenna 320 via a separate transmitter (illustrated as TX within transceiver 318). Each transmitter may modulate an RF carrier with a respective spatial stream for transmission.

At the UE 350, each receiver (illustrated as RX within transceiver 354) receives a signal through its respective antenna 352. Each receiver recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 310, the controller/processor 359 provides RRC layer functionality associated with system information (such as MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters (illustrated as TX within transceiver 354). Each transmitter may modulate an RF carrier with a respective spatial stream for transmission.

The UL transmission is processed at the base station 310 in a manner similar to that described in connection with the receiver function at the UE 350. Each receiver (illustrated as RX within transceiver 318) receives a signal through its respective antenna 320. Each receiver recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK or NACK protocol to support HARQ operations.

At least one of the TX processor 368, the RX processor 356, and the controller/processor 359 may be configured to perform aspects in connection with the CSI Tx component 140 of FIG. 1. For example, the memory 360 may include executable instructions defining the CSI Tx component 140. The TX processor 368, the RX processor 356, and/or the controller/processor 359 may be configured to execute the CSI Tx component 140.

At least one of the TX processor 316, the RX processor 370, and the controller/processor 375 may be configured to perform aspects in connection with the CSI Rx component 120 of FIG. 1. For example, the memory 376 may include executable instructions defining the CSI Rx component 120. The TX processor 316, the RX processor 370, and/or the controller/processor 375 may be configured to execute the CSI Rx component 120.

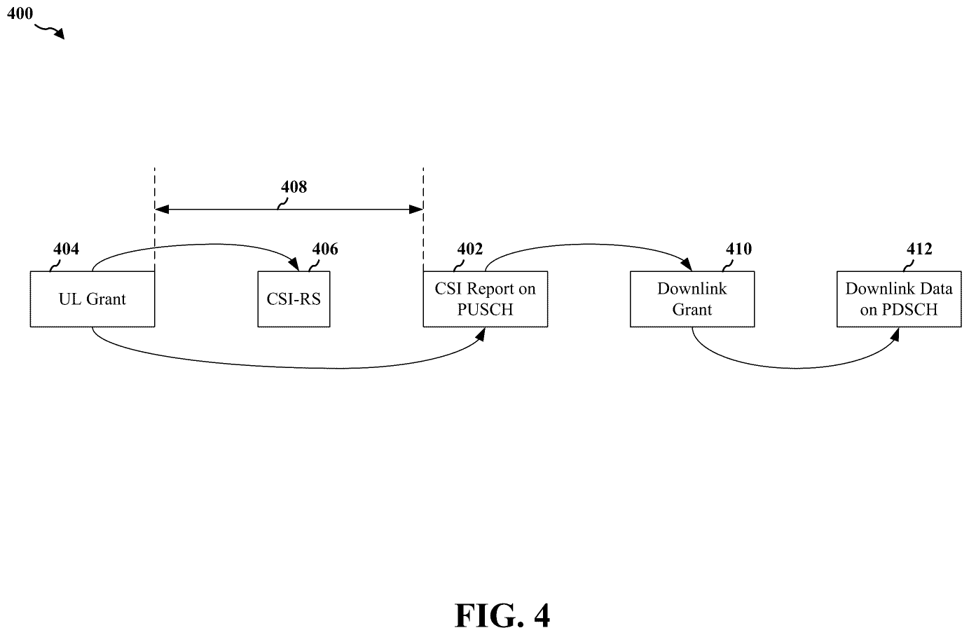

FIG. 4 illustrates an example 400 where a UE transmits an aperiodic CSI report 402 on PUSCH in response to an uplink grant 404 from a base station. In 5G NR, the base station may schedule the UE to transmit a CSI report as feedback to the network via a periodic CSI report on PUCCH. The base station also may schedule the UE to transmit semi-persistent CSI feedback on PUCCH or PUSCH. The base station also may schedule the UE to transmit aperiodic CSI feedback on PUSCH, which can be triggered by a UL grant. In other CSI reporting approaches, the base station may schedule the UE to transmit the aperiodic CSI feedback on PUCCH, which can be triggered by a DL grant. The CSI reports can be measured based on CSI-RS.

In some 5G NR approaches, the base station may schedule the UE to transmit an aperiodic CSI report (A-CSI) on PUSCH using the UL grant. In other 5G NR approaches, the base station may issue the DL grant to trigger the UE to transmit an aperiodic CSI report on PUCCH. This particular approach using PUCCH may enable faster A-CSI reporting than A-CSI reporting on PUSCH. For instance, the A-CSI reporting on PUCCH may provide the base station with more up-to-date CSI information, which in turn can improve PDSCH performance.

While the following example refers specifically to aperiodic CSI feedback based on CSI-RS, in other examples, the CSI feedback may be aperiodic and based on DMRS or other downlink signals for decoding PDSCH. In the example of FIG. 4, the UE may first receive uplink grant 404 which triggers aperiodic CSI-RS 406 and which schedules the PUSCH transmission including the aperiodic CSI report 402. The uplink grant 404 may also indicate a slot offset index 408 (e.g. K2), which may indicate the slot at which the UE transmits the PUSCH. The UE may measure CSI based on the aperiodic CSI-RS 406 (for example, by identifying CQI based on the RSRP or RSSI of the CSI-RS), and the UE may provide the CSI to the base station in the aperiodic CSI report 402. After receiving the CSI report, the base station may transmit a downlink grant 410 which schedules downlink data 412 on a PDSCH. The base station may also determine various parameters for the downlink data transmission on PDSCH based on the aperiodic CSI report 402 (e.g. MCS, rank, resource block allocation, precoder, and transmission power), and the base station may transmit the downlink data accordingly to the UE. For example, if the CSI report 402 includes CQI indicating that the UE determined the channel to have poor SINR, the base station may determine to decrease the MCS to improve the likelihood of successful reception of the downlink data 412.

In addition to uplink grants, the base station may transmit a downlink grant to the UE (e.g. a DCI scheduling a PDSCH transmission) which triggers aperiodic CSI-RS transmissions and CSI feedback. For example, the base station may provide DCI including a CSI trigger field (spanning a number Z bits), which indicates a CSI trigger state including a CSI report setting and a CSI-RS resource setting, and the UE may measure CSI and transmit the aperiodic CSI report in response to the DCI. The UE may provide the aperiodic CSI feedback on PUCCH in response to the DCI, as well as HARQ-ACK feedback on PUCCH in response to downlink data scheduled by the DCI. For example, when the downlink grant triggers an aperiodic CSI report, the UE may multiplex the aperiodic CSI report and the HARQ-ACK feedback in the same PUCCH resource (e.g., within a slot(s), subframe(s), or frame(s) scheduled for a single PUCCH transmission), or the UE may transmit the aperiodic CSI report and the HARQ-ACK feedback in separate PUCCH resources (e.g., within slot(s), subframe(s), or frame(s) respectively scheduled for different PUCCH transmissions). The aperiodic CSI report may be based on A-CSI (e.g., include CQI associated with SNR measurements of aperiodic CSI-RS), or based on PDSCH decoding (e.g., include CQI associated with SNR measurements of DMRS or based on log-likelihood ratios (LLRs) of the downlink data). In response to the CSI report, the base station may adjust MCS or other parameters to result in more reliable or faster, subsequent downlink transmissions. Thus, downlink grant-triggered, aperiodic CSI reporting may support reduced latency and increased reliability in communications.

The CSI report can be generated by either 1) measuring CSI-RS resources configured by the DCI, or 2) measuring A-CSI from PDSCH. In some scenarios, the base station may transmit a periodic CSI-RS or a semi-persistent CSI-RS immediately prior to transmission of the PDSCH, so the UE would need to decide which of the two CSI reports to transmit back to the base station on the PUCCH resource. In some aspects, the two CSI reports may have partially overlapping information, and the PDSCH can be considered as less aging since it may be safely assumed that it is transmitted after the CSI-RS.

In some aspects, the base station may trigger the UE to measure CSI-RS resources using a report configuration identifier (or referred to as “reportConfig”) when a DL DCI schedules PDSCH including a RRC configuration and a MAC CE-based triggering procedure that may be similar to aperiodic CSI-RS with the difference that DL DCI is the activation trigger without explicit signaling in the DCI). In some aspects, there may be two CSI-RS report configurations (denoted by respective report configuration identifiers), where 1) a first report configuration identifier is associated with aperiodic, periodic or semi-persistent CSI-RS resources, and 2) a second report configuration identifier is associated with aperiodic CSI-RS resources that are triggered implicitly by the DL DCI. In a second case, the CSI-RS report configurations may at least partially overlap on PUCCH with the PDSCH A-CSI report (e.g., A-CSI measured from PDSCH).

In some aspects, the UE may be scheduled to report multiple CSI reports, where the UE may be configured to measure CSI-RS on aperiodic, periodic or semi-persistent resources or through the innovative mechanism described above where the RRC configuration and/or the MAC CE-based triggering procedure may configure a window of time in which a CSI-RS resource can be triggered with any DL DCI or certain semi-persistent scheduling (SPS) index DCI. In this regard, there may be at least two sources for scheduling A-CSI reporting. In one configuration, there may be multiple CSI reports from two or more different sets of CSI-RS resources, in which one or more sets of CSI-RS resources are associated with periodic or semi-persistent CSI-RS and the other set of CSI-RS resources is associated with the implicit DL DCI triggering. With this new A-CSI reporting, which is triggered implicitly by the DL DCI, innovative prioritization and multiplexing rules may be implemented. In other aspects, the UE may be scheduled to report multiple CSI reports from one or more CSI-RS report configuration identifiers (e.g., from aperiodic, semi-persistent, periodic, implicit DL DCI triggering CSI-RS) and from the PDSCH (e.g., periodic CSI reporting every L PDSCH occasions).

In some aspects, two or more CSI report transmissions are said to collide if the CSI reports are scheduled to be transmitted simultaneously (e.g., a periodic CSI on PUCCH collides with an aperiodic CSI on PUCCH). Particularly, two CSI reports are said to collide if the time occupancy of the physical channels scheduled to carry the CSI reports overlap in at least one OFDM symbol and are transmitted on the same carrier. In this regard, some CSI reports may need to be multiplexed, dropped or omitted. It may also occur that a number of CSI reports scheduled to be transmitted simultaneously result in a significantly large payload size that may not fit into an uplink control information (UCI) container (e.g., due to HARQ-ACK and/or scheduling request (SR) additionally needs to be multiplexed).

When a UE is configured to transmit two colliding CSI reports, the UE may determine whether to multiplex or drop one or more of the CSI reports based on a priority. Legacy CSI reports may be associated with a priority for determining which reports to transmit when multiple reports are scheduled on the same resources. In some aspects, priority of a CSI report may be based on a function of a CSI report trigger (y), CSI report content (k), a serving cell index, and a report configuration ID. In some aspects, the base station may transmit a downlink configuration that defines a number of prioritization rules for the UE to know which CSI reports to prioritize in this case. For example, CSI reports may be first prioritized according to their time-domain behavior and physical channel, where more dynamic reports are given precedence over less dynamic reports and PUSCH has precedence over PUCCH. That is, an aperiodic report has priority over a semi-persistent report on PUSCH, which in turn has priority over a semi-persistent report on PUCCH, which has priority over a periodic CSI report. If multiple CSI reports with the same time-domain behavior and physical channel collide, the reports are further prioritized depending on CSI content, where beam reports (e.g., L1-RSRP reporting) has priority over regular CSI reports. In some aspects, the CSI report is typically conditioned on a serving beam, so if the beam is not correct, the utility of the CSI report is insignificant.

If further differentiation between CSI reports is required, the CSI reports can be further prioritized based on to which serving cell the CSI corresponds such as in the case of a carrier aggregation operation. That is, a CSI corresponding to a primary cell (e.g., referred to as a PCell) may have priority over a CSI corresponding to a secondary cell (e.g., referred to as a SCell). In still other aspects, to avoid any ambiguities in which a CSI report is to be transmitted, the CSI reports can be prioritized based on a report configuration identifier (e.g., referred to as “reportConfigID”).

The aforementioned prioritization rules may be applied so that a single CSI report can be transmitted by the UE in case of a potential CSI report collision with the exception of a potential collision between multiple PUCCH-based CSI reports. In this regard, the base station may configure the UE, via a CSI report configuration, with a larger multi-CSI PUCCH resource, where several CSI reports can be multiplexed in the same PUCCH resource in case of a potential collision. As a result, multiple CSI reports can be transmitted without exceeding a maximum UCI code rate when these CSI reports are transmitted on the multi-CSI PUCCH resource.

As discussed above, for example, with respect to FIG. 4, a CSI-RS may also be used as a channel measurement resource. In such cases, the CSI report configuration as described with respect to FIG. 4 may be used for either DL DCI implicitly triggered CSI feedback, CSI-RS based CSI feedback, or downlink grant based CSI feedback. A CSI for CSI-RS based reporting may include a CRI, PMI, RI, CQI, or any combination thereof as configured in the CSI report configuration.

In some implementations, the CSI report 402 may include an explicit CQI report. For example, the CSI report 402 may represent the CQI as a 4-bit index to a CQI table or a 2-bit differential from a previously reported CQI value. The CSI report 402 may also include a RI indicating the rank used to determine the reported CQI.

For both UE initiated CSI reporting and DL grant based CSI report, the base station may configure a dedicated uplink resource. In some implementations, the dedicated uplink resource may be PUCCH and/or PUSCH resource. For example, the base station may transmit an RRC configuration message to configure a list of PUCCH or PUSCH resource configurations. Each resource configuration may include at least a frequency domain resource allocation (FDRA), a PUCCH format, and a time domain resource allocation (TDRA). The FDRA may indicate one or more resource elements (REs). The TDRA may indicate a starting symbol and length in a slot.

The UE may select resources from the list of PUCCH or PUSCH resource configurations for the CSI report. In some implementations, for example, the UE 104 may determine the PUCCH/PUSCH resource per report/resource configuration or trigger state configuration. There may be a 1-to-1 mapping between PUCCH/PUSCH for CSI and the report/resource/trigger state configuration. In some implementations, the PUCCH/PUSCH resource may be determined per HARQ-ACK process number. In some implementations, the PUCCH/PUSCH resource is determined via a dedicated field in the DL grant. In some implementations, the PUCCH/PUSCH resource for CSI feedback is based on a resource wise (1-to-1) mapping to the PUCCH resource used for HARQ-ACK, and the actually used the PUCCH/PUSCH for CSI feedback is determined based on a legacy PUCCH-resource-indicator field provided in the DL DCI. For example, a codepoint in the DL DCI indicates a pair of PUCCH resources for HARQ-ACK and PUCCH/PUSCH resource for CSI.

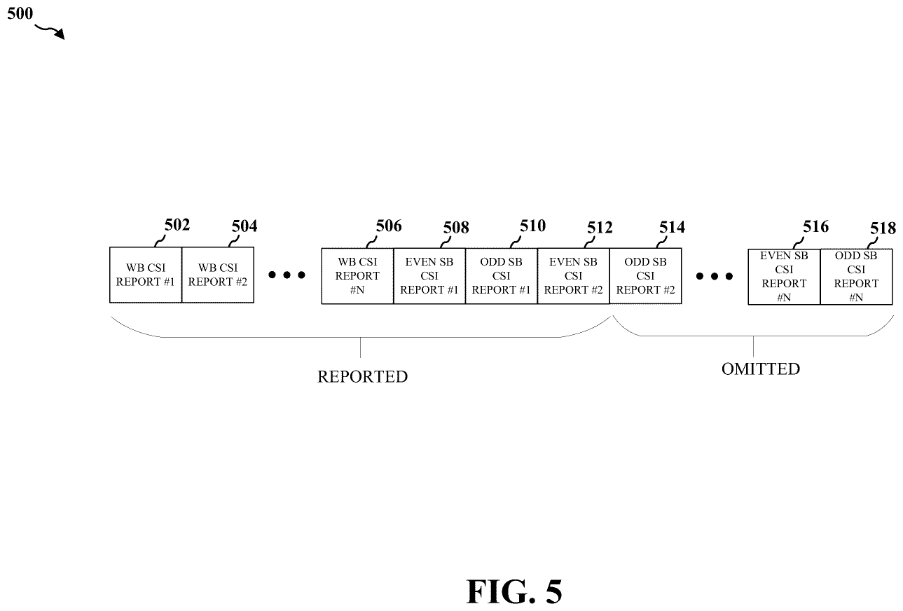

FIG. 5 is a diagram illustrating an example 500 of partial CSI omission for PUSCH-based CSI reporting. For PUSCH-based CSI reporting and Type II CSI reporting, the CSI payload size can vary significantly depending on the resource indicator (RI) selection. For example, for Type II CSI reporting, the precoding matrix indicator (PMI) payload for RI=2 is almost double to that of RI=1. Since the RI selection is not known to the base station prior to scheduling an aperiodic CSI report on the PUSCH, the base station may need to allocate PUSCH resources (e.g., in frequency and time domains) by estimating what RI selection the UE is likely to make based at least in part on historical RI reports, among others. Thus, the base station may allocate PUSCH resources with an assumption that the UE can report for RI=1, but the UE instead may actually report for RI=2. In this case, the CSI payload may not fit in the PUSCH container (e.g., the UCI code rate may be too large or un-coded systematic bits may not fit). A legacy CSI reporting approach may include dropping the entire CSI report; however, this would be a waste of resources. Another legacy CSI reporting approach includes partial CSI omission, where a portion of the CSI is still reported to the network. For example, the retained portion of the CSI can provide some utility to the base station and at least provide information about the RI selection so that the base station can allocate a proper PUSCH resource for a next aperiodic CSI request.

The partial CSI omission may be performed by ordering the CSI content in a particular order. If the base station schedules multiple CSI reports to be transmitted on PUSCH, the wideband CSI components (e.g., the wideband PMI and CQI) for all the CSI reports can be mapped to the most significant bits of the UCI. As illustrated in FIG. 5, wideband CSI components 502, 504, 506 are mapped to the most significant bit locations of the UCI. The subband CSI components for each CSI report can be mapped according to some priority rules, where a subband CSI component for even-numbered subbands are mapped first, followed by a subband CSI component for odd-numbered subbands. As illustrated in FIG. 5, even sideband CSI component 508 is mapped first, followed by odd sideband CSI component 510 and so on. If the resulting code rate of the UCI exceeds a code rate threshold, a portion of the least-significant-bits of the UCI can be omitted, until the UCI code rate falls below the code rate threshold. This may result in the subband CSI components for odd-numbered subbands for a CSI report being omitted first. As illustrated in FIG. 5, the resulting code rate of the UCI allows for wideband CSI components 502, 504, 506 along with the sideband CSI components 508, 510 and 512 to be reported, whereas sideband CSI components 514, 516, 518 to be omitted from reporting. Although some subband CSI components are omitted, the base station can have subband PMI and CQI for every other subband in the frequency domain and can therefore interpolate the PMI/CQI between two reported subbands to attempt to estimate the missing (or omitted) PMI/CQI values for the subband. While this approach may not result in a complete reconstruction of the original CSI content, the reconstructed CSI report by interpolation provides advantages over another approach of omitting an entire chunk of CSI for consecutive subbands.

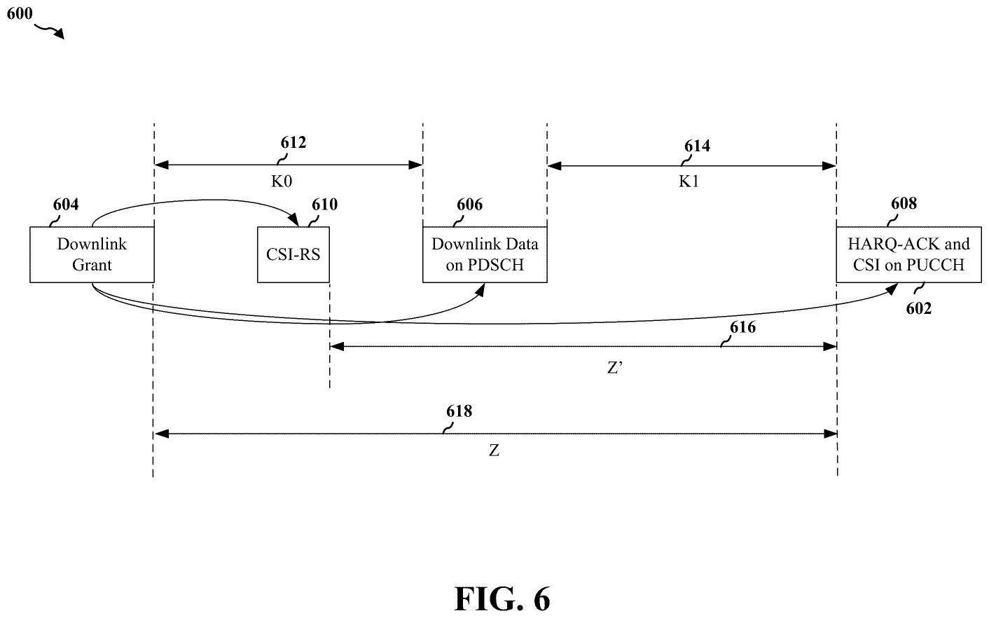

FIG. 6 illustrates an example 600, where a UE transmits an aperiodic CSI report 602 on PUCCH in response to a downlink grant 604 from a base station, where downlink grant 604 schedules downlink data 606 on PDSCH, and where the UE transmits HARQ-ACK feedback 608 on PUCCH in response to the downlink data. In particular, FIG. 6 illustrates the example where the UE transmits the HARQ-ACK feedback 608 and aperiodic CSI report 602 in the same PUCCH resource. Moreover, while these examples refer specifically to aperiodic CSI feedback based on CSI-RS 610 triggered by downlink grant 604, in other examples, the CSI feedback may be based on DMRS or other downlink signals in PDSCH for decoding the downlink data 606.

In the example of FIG. 6, the UE may first receive downlink grant 604, which triggers aperiodic CSI-RS 610 and which schedules the PDSCH transmission including the downlink data 606. The downlink grant 604 may also indicate a slot offset index 612 (e.g. K0), which may indicate the slot at which the base station transmits the PDSCH. The downlink grant may further indicate to the UE whether to transmit the aperiodic CSI report 602 and the HARQ-ACK feedback 608 in the same PUCCH resource or in different PUCCH resources. In response to receiving the downlink grant triggering aperiodic CSI reporting, the UE may measure CSI based on the aperiodic CSI-RS 610 or based on the PDSCH including the downlink data 606 (for example, by identifying CQI based on the RSRP or RSSI of the CSI-RS, DMRS, etc.), and the UE may provide the CSI to the base station in the aperiodic CSI report 602. The UE may also provide the HARQ-ACK feedback 608 to the base station in response to the downlink data 606 after a slot offset 614 following receipt of the downlink data (e.g. K1). After receiving the CSI report, the base station may modify, MCS, rank, RB allocation, precoder, transmission power, or other parameters for subsequent downlink data transmissions accordingly.

Thus, in response to a downlink grant, a UE may provide aperiodic CSI on PUCCH with HARQ-ACK feedback in the same PUCCH resources or in separate PUCCH resources. Alternatively, the UE may provide the aperiodic CSI on PUSCH.

In FIG. 6, the example 600 also includes an example CSI reporting scheduling for a PUCCH or PUSCH resource for CSI. The UE 104 may determine the slot of the PUCCH/PUSCH carrying a CSI report based on the measurement resource. For UE initiated CSI reporting, the measurement resource may be the PDSCH. In some implementations, the periodicity and slot offset (relative to slot 0) may configured via RRC together with the resource configuration. For example, the reserved uplink resources may be configured as a configured grant PUSCH or a PUCCH resource similar to the PUCCH-CSI-resource used for periodic CSI reporting. The CSI report may be transmitted on PUCCH/PUSCH resources on specified slots. The UE may transmit the CSI report via the most recent PUCCH that satisfies the CSI timeline. The CSI timeline specifies a minimum gap (Z′) 616 between the UL resource carrying the CSI and the measurement resource, and may also specify a minimum gap (Z) 618 between the UL resource carrying the CSI and the CSI request.

In some CSI reporting approaches, a DL grant can trigger A-CSI reporting on PUCCH for reduced latency and increased reliability. For example, the DL grant can include a DCI for scheduling the UE to transmit the aperiodic CSI report on PUCCH. In some aspects, the DL DCI includes a CSI trigger field (e.g., Z bits) to explicitly indicate a CSI trigger state that includes a CSI report setting and a CSI-RS resource setting. However, this approach requires a new format for the DL DCI to accommodate the additional bits of information. The subject technology of the present disclosure provides for no requirement in changing the DCI format to enable triggering of A-CSI reporting on PUCCH. Additionally, the present disclosure provides for prioritization and multiplexing considerations for DL DCI implicit triggering of A-CSI reporting based on CSI-RS.

In order to avoid configuration of CSI-RS resources triggered explicitly by DL DCI and are used to measure the A-CSI, the present disclosure describes multiple innovative approaches for A-CSI reporting without the need to modify the DCI format. In some aspects, a RRC configuration can configure the CSI-RS and PUCCH resources as well as define a time measurement between the DL DCI and CSI-RS resource(s). The RRC configuration also may configure time measurement parameters, z and z′. In other aspects, the MAC-CE can downselect the resources (assuming multiple resources are configured in the RRC configuration) as well as changing the offsets. The MAC-CE also may configure the time measurement parameters, z and z′.

In an aspect, CSI reporting may be dynamically activated or deactivated. For example, the base station 102 may transmit an activation/deactivation command, and the UE 104 may receive the activation/deactivation command. The activation/deactivation command may be a MAC-CE or a DCI. In some implementations, the activation command activates CSI feedback until the UE receives a deactivation command. In some implementations, the activation command activates the CSI feedback for a number of CSI report opportunities. For example, the activation command may indicate a number of uplink resources on which the UE may transmit a CSI report. The CSI feedback may end after the last possible CSI report without the UE receiving a deactivation command. Use of an activation/deactivation command may allow dedicated UL resources to be used for other purposes when CSI feedback is deactivated. In some aspects, the MAC-CE activates an activation window and configures the activation window with a length Y. In some aspects, the length Y can reconfigured and/or updated by RRC configuration and/or MAC-CE. In other aspects, the MAC-CE can activate a procedure referred to as a DCI trigger CSI-RS, in which a DL dynamic grant (DG) and/or a configured grant (CG) DCI serve as triggers. That is, after the MAC-CE activation, the UE can expect to receive CSI-RS resources after X slots/symbols (e.g., the time difference between z and z′) from receiving the DL DCI (e.g., received at a first OFDM symbol or at a last OFDM symbol). In some aspects, a first MAC-CE can activate the activation window, and a second MAC-CE (subsequent to the first MAC-CE) can deactivate the activation window.

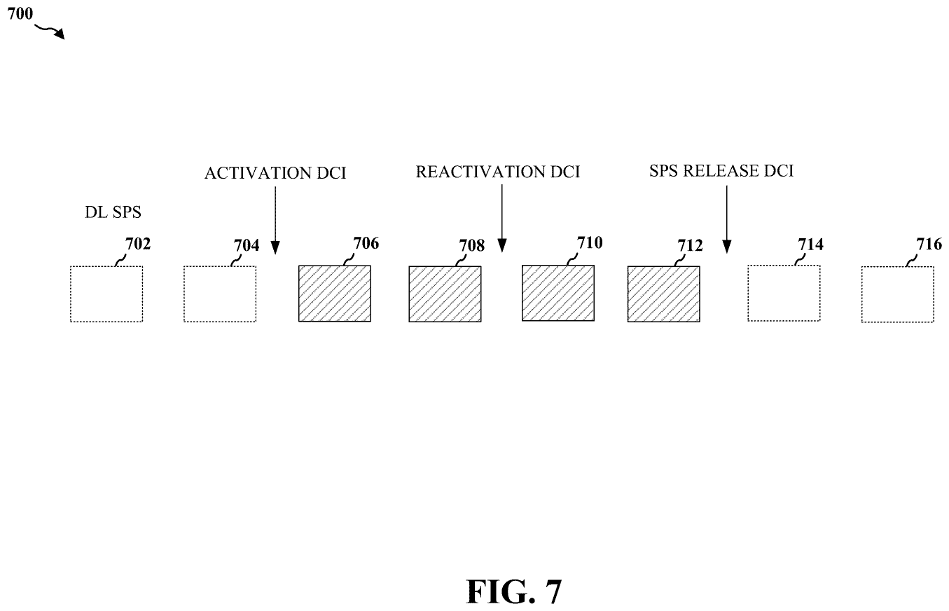

FIG. 7 is a diagram 700 illustrating example downlink control information signaling for activation and deactivation of CSI reporting based on a semi-persistent scheduling (SPS) configuration. As illustrated in FIG. 7, the base station may send downlink SPS signaling (e.g., 702, 704); however, the UE may not monitor these downlink SPS signals because a corresponding SPS configuration is not yet active at this point. In some aspects, CSI reporting may be dynamically activated or deactivated based on SPS configuration. For example, a RRC configuration can configure SPS periodicity and HARQ-ACK feedback resources. In particular, the dynamic activation and deactivation may be triggered by a SPS activation/reactivation DCI and a SPS release DCI. As illustrated in FIG. 7, the base station sends SPS activation DCI 706, 708. In this regard, the base station can use the SPS activation DCI 706, 708 to activate a certain configured SPS. In the SPS activation DCI 706 and 708, the base station can indicate transmission (Tx) parameters, such as MCS, resource block (RB) allocation, and/or antenna ports of a SPS transmission. The base station sends SPS reactivation DCI 710, 712 for reactivation. In some aspects, the base station can use the SPS reactivation DCI 710, 712 to modify the Tx parameters (e.g., MCS, RB allocation, antenna ports of the SPS). For deactivation of the SPS, the base station sends SPS release DCI 714, 716 and uses the SPS release DCI 714, 716 to deactivate a configured SPS.

Instead of activating a configured SPS for every DL DCI reception, the base station can enable the SPS activation for all dynamic grants and SPS, exclusively for dynamic grants and a select number of SPS, or exclusively for SPS. In some aspects, these select SPS activation scenarios can be specified in the RRC configuration or in the MAC-CE. For SPS, the MAC-CE can configure certain SPS indices to trigger the CSI-RS. For example, the MAC-CE can activate the CSI reporting procedure such that the UE can expect to receive the CSI-RS only when SPS activation/reactivation DCI indicates at least one of the configured SPS indices (e.g., SPS indices 0/1/2/3).

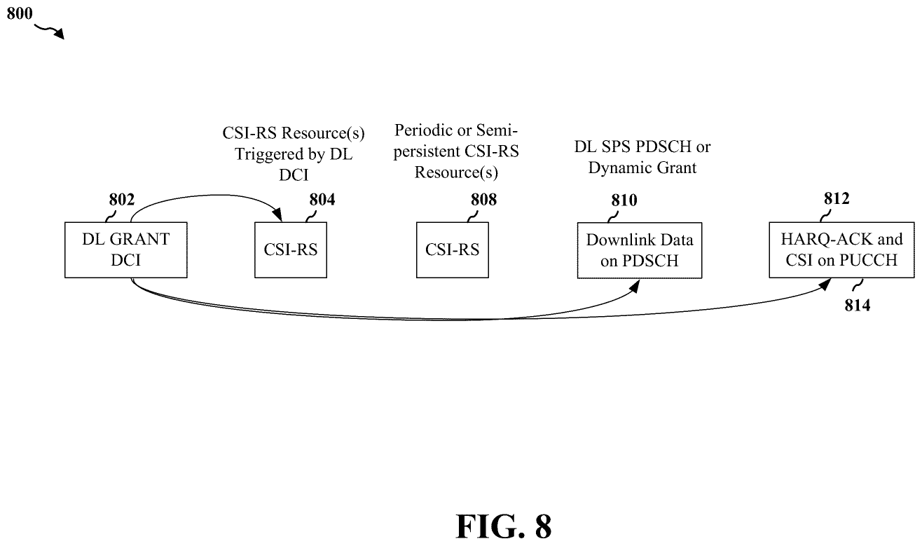

FIG. 8 is a diagram 800 illustrating example transmissions of an aperiodic CSI report in response to a downlink grant. In the example of FIG. 8, the UE may first receive downlink grant 802, which schedules the PDSCH transmission including the downlink data 810. In some aspects, the downlink grant 802 may include a downlink DCI that implicitly triggers CSI-RS 804. In some aspects, the UE also may receive CSI-RS 808, which may be sent on periodic or semi-persistent CSI-RS resources. The downlink grant 802 may further indicate to the UE whether to transmit the aperiodic CSI report 814 and the HARQ-ACK feedback 812 in the same PUCCH resource or in different PUCCH resources. In response to receiving the downlink grant triggering aperiodic CSI reporting, the UE may measure CSI based on the implicitly-triggered CSI-RS 804, the CSI-RS resource 808 or based on the PDSCH including the downlink data 810 (for example, by identifying CQI based on the RSRP or RSSI of the CSI-RS, DMRS, etc.), and the UE may provide the CSI to the base station in the aperiodic CSI report 814. The UE may also provide the HARQ-ACK feedback 812 to the base station in response to the downlink data 810.

In some implementations, the base station may schedule the UE to report both DL-triggered A-CSI and aperiodic, periodic or semi-persistent CSI based on CSI-RS. In this regard, the two or more CSI reports can be prioritized based on corresponding report configuration IDs, which can allow for the multiple CSI reports to be multiplexed and transmitted on the same PUCCH resource.

In some aspects, the UE may monitor for a particular CSI report trigger event to occur, such as when report configuration IDs related to periodic CSI-RS, aperiodic CSI-RS and/or semi-persistent CSI-RS resources and that related to resources corresponding to the A-CSI implicitly-triggered by DL DCI are scheduled within a specified time window to use the same PUCCH resources.

In one configuration, if the particular CSI report trigger event is detected, then the UE may be scheduled to transmit the A-CSI report based on a report configuration ID corresponding to a particular CSI-RS resource that is received last in time at the UE. For example, the UE may measure the A-CSI based on one of the aperiodic, periodic, or semi-persistent CSI-RS resources since the periodic/aperiodic/semi-persistent CSI-RS resources are received after CSI-RS resources implicitly triggered by the DL DCI.

In one configuration, if the particular CSI report trigger event is detected, then the UE may be scheduled to transmit the A-CSI report based on all report configuration IDs provided that the UE supports sending A-CSI reports within the same interval (assuming the later source timeline is satisfied). In some aspects, the UE can transmit a separate report for each report configuration ID, which may translate into doubling the report size. In some aspects, this approach in sending separate CSI reports may follow multiplexing rules with omission rules, where portions of the CSI on different subbands are multiplexed for reporting while other portions of the CSI (e.g., the least significant bits) may be omitted from reporting. In some aspects, the base station may configure the UE to prioritize the DL DCI implicitly-triggered A-CSI report over the CSI report based on the periodic, aperiodic, semi-persistent CSI-RS resources. In some aspects, the base station may configure the UE to prioritize the periodic or semi-persistent CSI reports over the DL DCI implicitly-triggered A-CSI report. In some aspects, the base station may configure the UE to prioritize the CSI report based on the CSI-RS resources that are received first in time. In some aspects, the base station may configure the UE to prioritize the CSI report based on the CSI-RS resources that are received last in time. In some implementations, the base station may configure the UE to merge multiple CSI reports together by using measurements based on a channel resource indication as if the merged CSI reports are associated with a single resource with multiple CSI-RS resources. In this regard, by having the UE also report the report configuration ID that has associated CSI-RS resources, results in improved measurements. For example, the UE may transmit the CSI report indicating the corresponding report configuration ID and CSI measurements (e.g., CQI, RI, PMI).

In one configuration, if the particular CSI report trigger event is detected, then the UE may be scheduled to transmit the A-CSI report based on the report configuration ID corresponding to the CSI-RS resources that are received first in time, which may afford the UE a more relaxed timeline to compute channel state information feedback (CSF). As illustrated in FIG. 8, the A-CSI report may be based on the report configuration ID corresponding to CSI-RS resources triggered by the DL DCI as these resources are receive first in time.

In one configuration, the base station may configure the UE to prioritize the periodic, aperiodic and semi-persistent CSI-RS resources over the CSI-RS resources that correspond to the DL DCI implicitly triggered A-CSI reporting. In this regard, when the particular CSI report trigger event is detected, the UE may drop the DL DCI implicitly triggered A-CSI report relative to CSI reports based on the periodic and semi-persistent CSI-RS resources.

In one configuration, the base station may configure the UE to prioritize the CSI-RS resources that correspond to the DL DCI implicitly triggered A-CSI reporting over the periodic, aperiodic and semi-persistent CSI-RS resources. In this regard, when the particular CSI report trigger event is detected, the UE may drop the CSI report based on the periodic and semi-persistent CSI-RS resources relative to the DL DCI implicitly triggered A-CSI report.

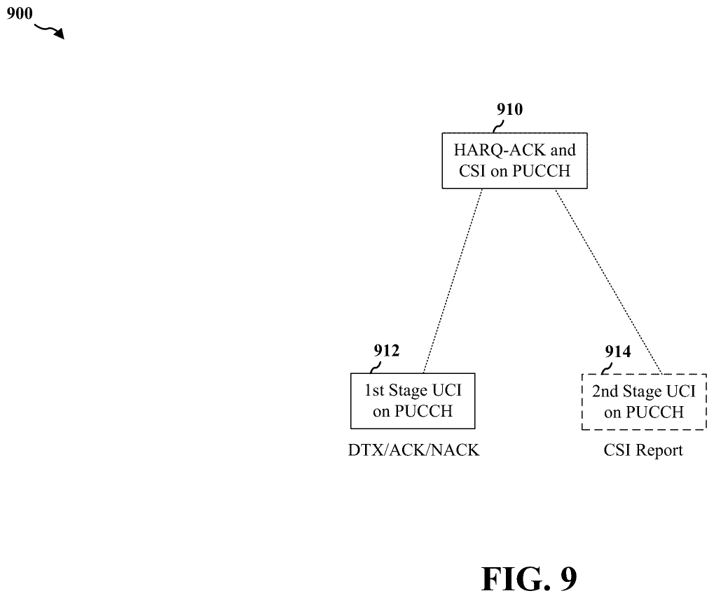

FIG. 9 illustrates an example 900 of a two-stage UCI for reporting CSI feedback and HARQ feedback. In some implementations, the base station may configure the UE to report HARQ-feedback along with CSI feedback on PUCCH (e.g., 910). The UCI may be organized in two stages, with a first stage 912 including the HARQ-ACK feedback, such as discontinuous transmission (DTX), ACK, or NACK, and a second stage 914 including the CSI report (e.g., CQI, RI, PMI, MCS, SINR, among others). In some aspects, the first stage 912 includes two bits when the DTX reporting is enabled. In one configuration, the first stage 912 of the UCI can indicate the report configuration ID that corresponds to the best measurements in the use case of merging the CSI reports. To avoid sending the report configuration ID, the UE can order the report configuration IDs based on the timing of CSI-RS resource(s) (e.g., first CSI-RS resource within a resource set), then the UE can indicate a new index corresponding to a report configuration ID. For example, the UE can order the CSI-RS resources based on when they arrive in time (or received at the UE) relative to the DL DCI as 0, 1, 2, . . . , M, where 0 is first in time, 1 is second in time, and so on.

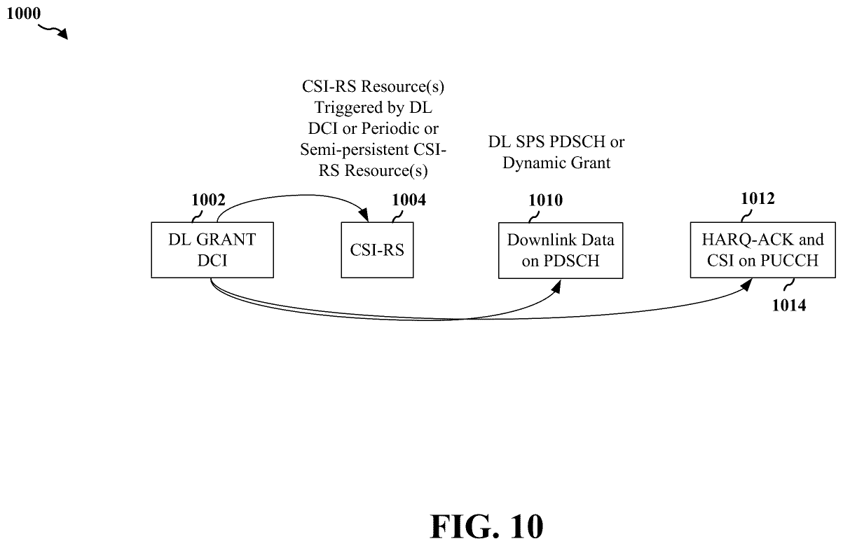

FIG. 10 is a diagram 1000 illustrating example transmissions of an aperiodic CSI report in response to a downlink grant. In the example of FIG. 10, the UE may first receive downlink grant 1002, which schedules the PDSCH transmission including the downlink data 1010. In some aspects, the downlink grant 1002 may include a downlink DCI that implicitly triggers CSI-RS 1004. In other aspects, the CSI-RS 1004 may be sent on periodic or semi-persistent CSI-RS resources. In some aspects, the CSI-RS 1004 may further indicate to the UE whether to transmit the aperiodic CSI report 1014 and the HARQ-ACK feedback 1012 in the same PUCCH resource or in different PUCCH resources. In response to receiving the downlink grant triggering aperiodic CSI reporting, the UE may measure CSI based on the CSI-RS 1004 or based on the PDSCH including the downlink data 1010 (for example, by identifying CQI based on the RSRP or RSSI of the CSI-RS, DMRS, etc.), and the UE may provide the CSI to the base station in the aperiodic CSI report 1014. The UE may also provide the HARQ-ACK feedback 1012 to the base station in response to the downlink data 1010.

In some implementations, the base station may schedule the UE to report both PDSCH-based CSI and CSI triggered by DL DCI or aperiodic, periodic or semi-persistent CSI-RS resources. In some aspects, the PDSCH-based CSI may have a periodicity and the A-CSI report that is implicitly triggered by DL DCI may be activated such that both CSI reports may be scheduled to transmit on the same PUCCH slot. In other aspects, the PDSCH-based CSI and the periodic, aperiodic, or semi-persistent CSI report may be activated such that both CSI reports may be scheduled to transmit on the same PUCCH slot.

In some implementations, based on the amount of interference (e.g., measured as interference rank and/or power) observed at the UE and the block error rate (BLER) and/or bit error rate (BER) measured at the UE's receiver, the UE can decide to transmit one of the CSI reports or a combination thereof. In some aspects, a PDSCH transmission may include 1) CSI information that is common with CSI-RS, or 2) CSI information different than CSI-RS, where the CSI-RS can be unprecoded, configured to be wideband, and has more ports than PDSCH.

In one configuration, the base station may schedule the UE to send a CSI-RS-based CSI report with size Y bits. In some aspects, the CSI-RS-based CSI report can be used to change measurements such as CQI, PMI, channel rank, L1-RSRP, and/or strongest layer indicator (SLI). In some implementations, the A-CSI based on CSI-RS triggered by DL DCI may cancel the PDSCH-based A-CSI.

In one configuration, the base station may schedule the UE to send a PDSCH-based CSI report with size X bits. In some aspects, the PDSCH-based CSI report may have more updated CQI information than the CSI-RS-based CSI report based on precoded data and may contain information relating to BLER, BER, CQI, channel rank, log likelihood ratios (LLRs) status, parity check status, and/or best next redundancy version (RV). In some aspects, the aforementioned information, with the exception of CQI and channel rank, may not be determined without PDSCH reception and decoding.

In one configuration, the base station may schedule the UE to send the PDSCH-based CSI report along with different contents based on the CSI-RS resources, such as PMI. In some aspects, PDSCH-based CSI report may include a bit size of X+Y′, where Y′<Y bits. In some aspects, this approach may be configured by the base station through a RRC configuration and/or MAC-CE, particularly by activation via the MAC CE.

In one configuration, the base station may schedule the UE to send the CSI-RS-based CSI report and the PDSCH-based CSI report as a merged report with a total bit size of X+Y bits. In some aspects, this approach may be configured by the base station through a RRC configuration and/or MAC-CE, particularly by activation via the MAC CE. This approach also may provide the CSI port with more information about CQI change over time and temporal characteristics of the measurements as well as any needed information for robust retransmissions or next transmissions. In some aspects, this approach in sending a combination of both CSI reports may follow multiplexing rules with omission rules, where portions of the CSI on different subbands are multiplexed for reporting while other portions of the CSI (e.g., at least significant bits) may be omitted from reporting. In some aspects, the CSI reporting may include additional information that is PDSCH specific (e.g., BER, BLER, RV index) and can be assigned with higher or lower priority depending on implementation.

In one configuration of the merged report, if both CSI reports have similar information (e.g., the amount of overlapping information between the two reports exceeds a threshold) or the number of changes required is below a certain threshold, the UE can select one of two CSI reports and generate the final CSI report with the corresponding CSI payload.

In some implementations, the base station may configure the UE to provide the UCI feedback in two stages. In some aspects, the first stage includes the HARQ-ACK feedback, such as DTX, ACK, or NACK. In some aspects, the UE sends the type of the report to the base station as part of HARQ-ACK. In some aspects, the first stage includes two bits when the DTX reporting is enabled.

In one configuration, the UE indicates the type of report as DTX. This may occur when the UE is not able to decode the DCI. In one configuration, the UE sends an ACK and the HARQ-ACK feedback also indicates that the CSI report is based on PDSCH. In other aspects, the UE sends a NACK and the HARQ-ACK feedback also indicates that the CSI report is based on PDSCH.

In another configuration, the UE sends an ACK and the HARQ-ACK feedback also indicates that the CSI report is based on CSI-RS. In other aspects, the UE sends a NACK and the HARQ-ACK feedback also indicates that the CSI report is based on CSI-RS. In still another configuration, the UE sends an ACK and the HARQ-ACK feedback also indicates that the CSI report is based on both the CSI-RS and PDSCH. In other aspects, the UE sends a NACK and the HARQ-ACK feedback also indicates that the CSI report is based on both the CSI-RS and PDSCH.

In some aspects, the aforementioned approaches in CSI reporting allow for capability considerations, such as if the UE is unable to send a CSI report on time, the UE can alternatively send the next available report. For example, the UE can send either the CSI report based on CSI-RS resources or CSI report based on PDSCH. The base station can capture and/or determine the payload size (e.g., X, Y, or X+Y) for the selected CSI report based on the first stage UCI. In some aspects, the size variables, X and Y, may be reported from the base station to the UE via RRC configuration, MAC-CE or DCI.

In some aspects, the second stage of the UCI may indicate the CSI report and may occupy multiple PUCCH resources, where the PUCCH resources are selected and determined based on the final CSI report selected from the first stage UCI. In some aspects, the time and frequency locations (or the resources used) can be determined by the base station based on the first stage UCI.

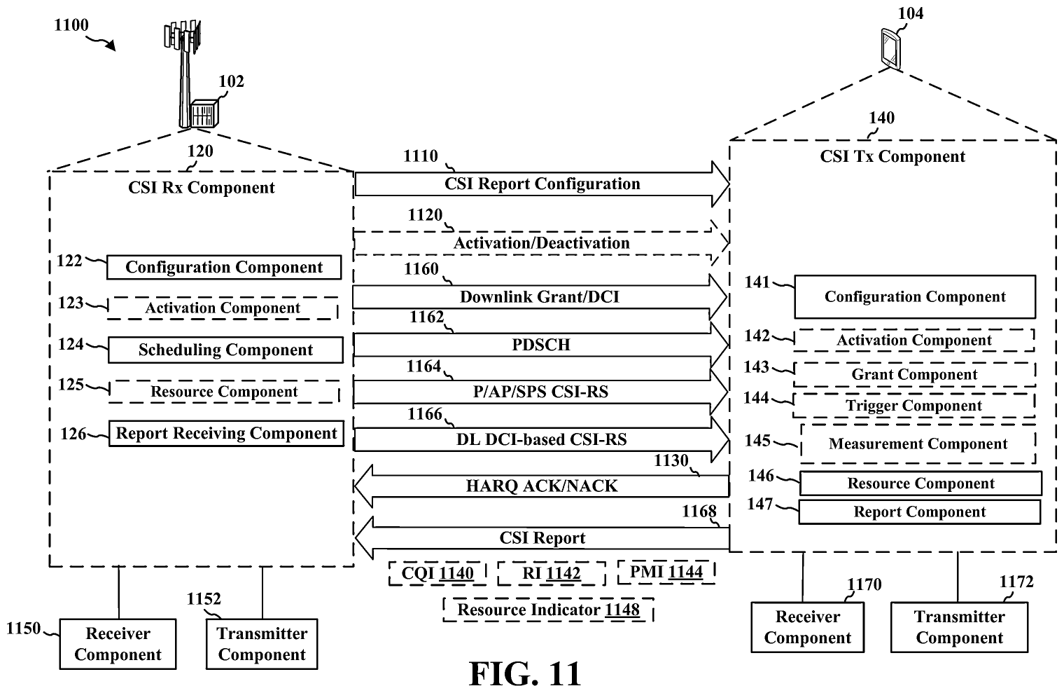

FIG. 11 is a diagram 1100 illustrating example communications and components of a base station 102 and a UE 104. The UE 104 may include the CSI Tx component 140. The base station 102 may include the CSI Rx component 120. The CSI Rx component 120 may be implemented by the memory 376 and the TX processor 316, the RX processor 370, and/or the controller/processor 375 of FIG. 3. For example, the memory 376 may store executable instructions defining the CSI Rx component 120 and the TX processor 316, the RX processor 370, and/or the controller/processor 375 may execute the instructions. The CSI Tx component 140 may be implemented by the memory 360 and the TX processor 368, the RX processor 356, and/or the controller/processor 359. For example, the memory 360 may store executable instructions defining the CSI Tx component 140 and the TX processor 368, the RX processor 356, and/or the controller/processor 359 may execute the instructions.

As discussed with respect to FIG. 1, the CSI Tx component 140 may include the configuration component 141, the activation component 142, the grant component 143, the trigger component 144, the measurement component 145, the resource component 146, and the report component 147. The CSI Tx component 140 be coupled with a receiver component 1170 and a transmitter component 1172 of the UE 104/350. The receiver component 1170 may include, for example, a radio-frequency (RF) receiver for receiving the signals described herein. The transmitter component 1172 may include for example, an RF transmitter for transmitting the signals described herein. In some implementations, the receiver component 1170 and the transmitter component 1172 may be co-located in a transceiver such as transceiver 354 (FIG. 3).

The CSI Rx component 120 may include the configuration component 122, the scheduling component 124, and the report receiving component 126 as discussed above regarding FIG. 1. The CSI Rx component 120 also may optionally include an activation component 123 and a resource component 125. The CSI Rx component 120 also may be coupled with a receiver component 1150 and a transmitter component 1152 of the base station 102/310. The receiver component 1150 may include, for example, a RF receiver for receiving the signals described herein. The transmitter component 1152 may include for example, an RF transmitter for transmitting the signals described herein. In some implementations, the receiver component 1150 and the transmitter component 1152 may be co-located in a transceiver such as transceiver 318 (FIG. 3).

The configuration component 122 at the base station 102 may configure the UE 104 with a CSI report configuration 1110. The UE 104 may transmit the CSI report configuration 1110 as a RRC configuration message.

The activation component 123 at the base station 102 may transmit an activation/deactivation command 1120. The activation/deactivation command 1120 may activate or deactivate aperiodic CSI reporting. The activation/deactivation command 1120 may be a MAC-CE.

The scheduling component 124 may transmit a downlink grant 1160 that schedules a PDSCH 1162. In some implementations, the downlink grant 1160 may include a DCI that implicitly triggers the CSI-RS 1166 for A-CSI measurement.

The transmitter component 1152 may transmit the PDSCH 1162, the CSI-RS 1164 and the CSI-RS 1166.

The report receiving component 126 may receive the CSI report 1168 transmitted by the UE 104.

The configuration component 141 at the UE 104 may receive the CSI report configuration 1110.

The activation component 142 at the UE 104 may receive the activation/deactivation command 1120. The activation component 142 may determine whether a measurement window for CSI feedback is active based on the activation/deactivation command 1120.

The grant component 143 may receive the downlink grant 1160. The grant component 143 may determine the resources for the PDSCH 1162 based on the downlink grant.

The measurement component 145 may perform measurements of the PDSCH 1162, the CSI-RS 1166 implicitly triggered by the DCI and/or the CSI-RS 1164 based on the CSI report configuration 1110 and the downlink grant 1160.

The trigger component 144 may determine whether a CSI report has been triggered based on the downlink grant 1160 (implicitly triggered by the DCI), measurements of the PDSCH 520 and/or the CSI-RS 1164.

The resource component 146 may determine an uplink resource for reporting a PDSCH based CSI report, a downlink DCI based CSI report or CSI-RS based CSI report.

The report component 147 may generate a CSI report 1168 for transmission on the uplink resource. The report component 147 may multiplex multiple CSI reports based on a prioritization between different CSI reports. In other aspects, the report component 147 may determine whether to drop (and/or omit) the CSI report 1168 based on a priority of the CSI report 1168 if there are potential collisions between different CSI reports. The report component 147 may format the CSI report 1168 based on the uplink resource. The report component 147 may determine the content of the CSI report 1168. For example, the CSI report 550 may include one or more of: a CQI 1140, a RI 1142, a PMI 1144, or a resource indicator 1148, among others.

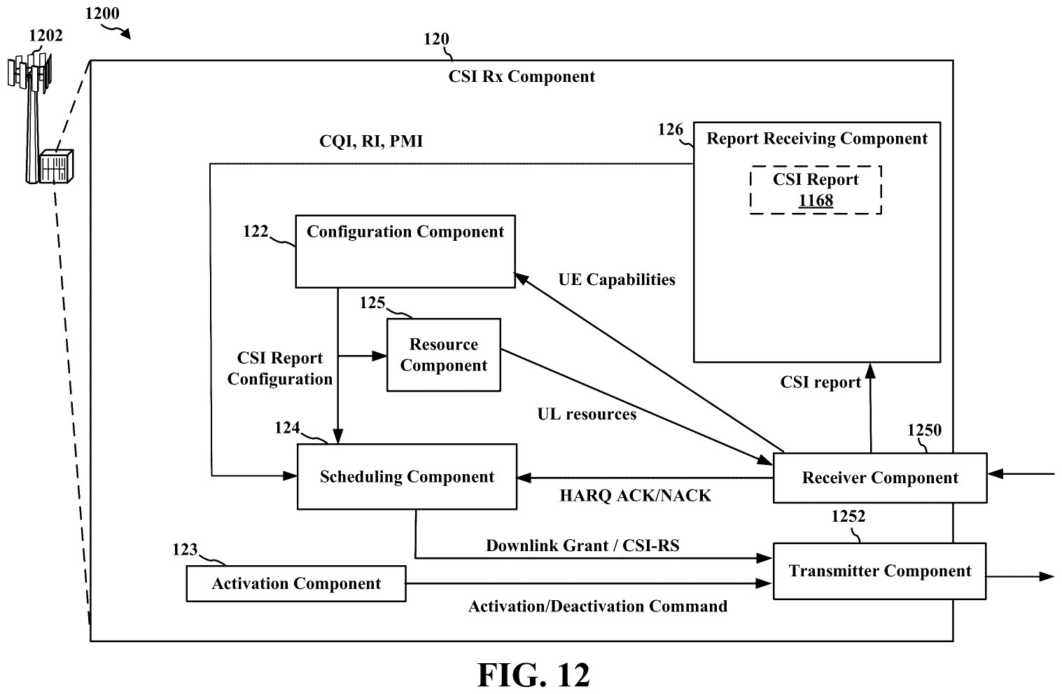

FIG. 12 is a conceptual data flow diagram 1200 illustrating the data flow between different means/components in an example base station 1202, which may be an example of the base station 102 including the CSI Rx component 120.

The receiver component 1250 may receive uplink signals from the UE 104 including the CSI report 1168 and the HARQ ACK/NACK 1230. In some implementations, the receiver component 1250 may receive UE capabilities. The receiver component 1250 may provide the CSI report 1168 to the report receiving component 126. The receiver component 1250 may provide the HARQ ACK/NACK 1230 to the scheduling component 124. The receiver component 1250 may provide the UE capabilities to the configuration component 122.

The report receiving component 126 may receive the CSI report from the receiver component 1250. The report receiving component 126 may extract content from the CSI report based on a format of the CSI report. For example, the report receiving component 126 may determine the CQI, RI, or PMI. The report receiving component 126 may also determine the measurement resources corresponding to the CSI report 1168 based on either the CSI report configurations or an indicator within the CSI report 1168. The report receiving component 126 may provide the CQI, RI, and/or PMI to the scheduling component 124.

The configuration component 122 may determine one or more CSI report configurations for the UE 104. For example, the configuration component 122 may determine the CSI report configurations based on UE capabilities of the UE 104. The configuration component 122 may provide the CSI report configurations to the scheduling component 124 and the resource component 125.

The resource component 125 may select reserved uplink resources on which the UE 104 may transmit the CSI report 1168. The configuration component 122 may configure the receiver component 1250 to monitor the reserved uplink resources.

The scheduling component 124 may receive the CSI report configuration from the configuration component 122. The scheduling component 124 may receive the HARQ ACK/NACK from the receiver component 1250. The scheduling component 124 may receive the CQI, RI, and/or PMI from the report receiving component 126. The scheduling component 124 may determine the resources for transmitting the PDSCH 520. For example, the scheduling component 124 may determine whether to transmit a retransmission or new data based on the HARQ ACK/NACK. The scheduling component 124 may determine a MCS for the PDSCH 1162 based on the CQI, RI, and/or PMI. In some implementations, the scheduling component 124 may determine whether to request a CSI report. For example, the scheduling component 124 may request a CSI report in response to a HARQ NACK. The scheduling component 124 may generate the downlink grant 1160 indicating the resources for the PDSCH 1162. In some implementations, the downlink grant 1160 may request a CSI report. In other implementations, the downlink grant 1160 includes a DCI that implicitly requests a CSI report based on the CSI-RS 1166. The scheduling component 124 may transmit the downlink grant 1160 via the transmitter component 1252. The scheduling component 124 may generate the CSI-RS 1164 and/or the CSI-RS 1166 indicating the resources for measuring the CSI. In some aspects, the scheduling component 124 may transmit the CSI-RS 1164 and/or the CSI-RS 1166 via the transmitter component 1252.

The activation component 123 may generate an activation/deactivation command 1220. For example, the activation component 123 may determine to activate CSI feedback based on variance in periodic CSI reports. Conversely, the activation component 123 may determine to deactivate the CSI feedback if a threshold time since a UE initiated CSI report has elapsed.

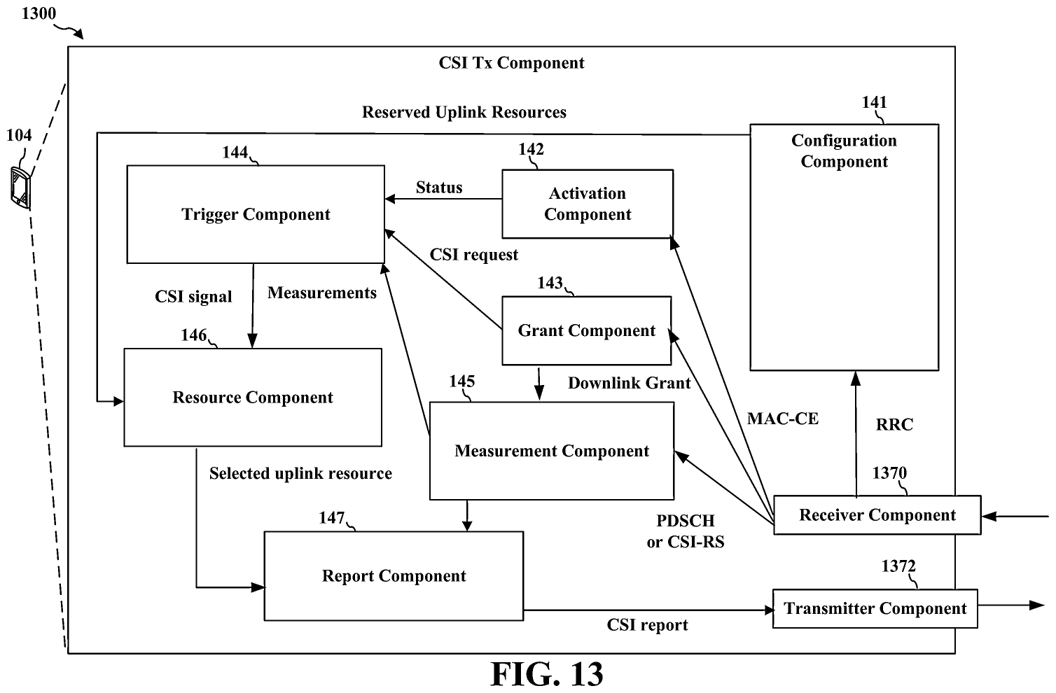

FIG. 13 is a conceptual data flow diagram 1300 illustrating the data flow between different means/components in an example UE 1304, which may be an example of the UE 104 and include the CSI Tx component 140.

The receiver component 1370 may receive uplink signals such as the CSI report configuration message 1110, the activation/deactivation command 1320, the downlink grant 1160, the PDSCH 1162, the CSI-RS 1164 and the CSI-RS 1166. The receiver component 1370 may provide the CSI report configuration message 1110 to the configuration component 141. The receiver component 1370 may provide the activation/deactivation command 1320 to the activation component 142. The receiver component 1370 may provide the downlink grant 1160 to the grant component 143. The receiver component 1370 may provide the PDSCH 1162, the CSI-RS 1164 and/or the CSI-RS 1166 to the measurement component 145.

The configuration component 141 may receive the CSI report configuration message 1110 from the receiver component 1370. The configuration component 141 may store one or more CSI report configurations. The configuration component 141 may configure the measurement component 145 to measure the measurement resources based on the CSI report configuration. The configuration component 141 may also configure the resource component 146 with reserved uplink resources indicated by the CSI report configuration.

The activation component 142 may receive the activation/deactivation command 1320, which may be a MAC-CE. The activation component 142 may determine whether aperiodic CSI reporting is activated or deactivated based on the activation/deactivation command 1320. The activation component 142 may provide an activation status to the trigger component 144.

The grant component 143 may receive the downlink grant 1160 from the receiver component 1370. In other aspects, the grant component 143 may determine whether the downlink grant 1160 explicitly requests a CSI report. The grant component 143 may provide the CSI request to the trigger component 144. The grant component 143 may also provide an indication of measurement resources to the measurement component 145.

The measurement component 145 may receive the signals received on the measurement resources (e.g., PDSCH 1160, CSI-RS 1164 or CSI-RS 1166) from the receiver component 1370. The measurement component 145 may determine various measurements based on the signals received on the measurement resources. In particular, the measurement component 145 may determine a feasible MCS and/or a CQI measurement. The measurement component 145 may provide the measurements to the trigger component 144.

The trigger component 144 may determine whether to transmit a CSI report based on the CSI report configurations, the activation status, the downlink grant 1160s, and/or the measurements. For example, the trigger component 144 may determine to transmit a CSI report in response to the grant component 143 indicating a CSI request. In some aspects, the trigger component 144 may determine to transmit a CSI report in response to an implicit triggering of the CSI-RS 1164 by the DCI. In other aspects, the trigger component 144 may determine to transmit a CSI report in response to the CSI-RS 1166 by the DCI. As another example, the trigger component 144 may determine to transmit a CSI report in response to the activation component 142 indicating an activation status. The trigger component 144 may provide a CSI signal to the resource component 146 indicating that a CSI report is to be transmitted.

The resource component 146 may receive the reserved uplink resources from the configuration component 141. The resource component 146 may receive the CSI signal from the trigger component 144. The resource component 146 may select an uplink resource for transmission of the CSI report from the reserved uplink resources. In some implementations, where the CSI report configuration may associate a reserved uplink resource with a prioritization of different measurement resources (e.g., PDSCH, CSI-RS), the resource component 146 may select the associated resources. In other implementations, the resource component 146 may select a next available uplink resource. The resource component 146 may provide the selected uplink resource to the report component 147.

The report component 147 may receive the measurements from the measurement component 145 and the selected uplink resource from the resource component 146. The report component 147 may generate a CSI report (or multiple CSI reports) based on the measurements and the selected uplink resource. For example, the report component 147 may determine content of the CSI report based on a number of available bits for the selected uplink resource. The report component 147 may also determine potential collisions with other CSI reports and determine which CSI reports to transmit in a particular order (of a multiplex transmission of CSI reports) based on a preconfigured priority for each CSI report (and/or associated measurement resource).

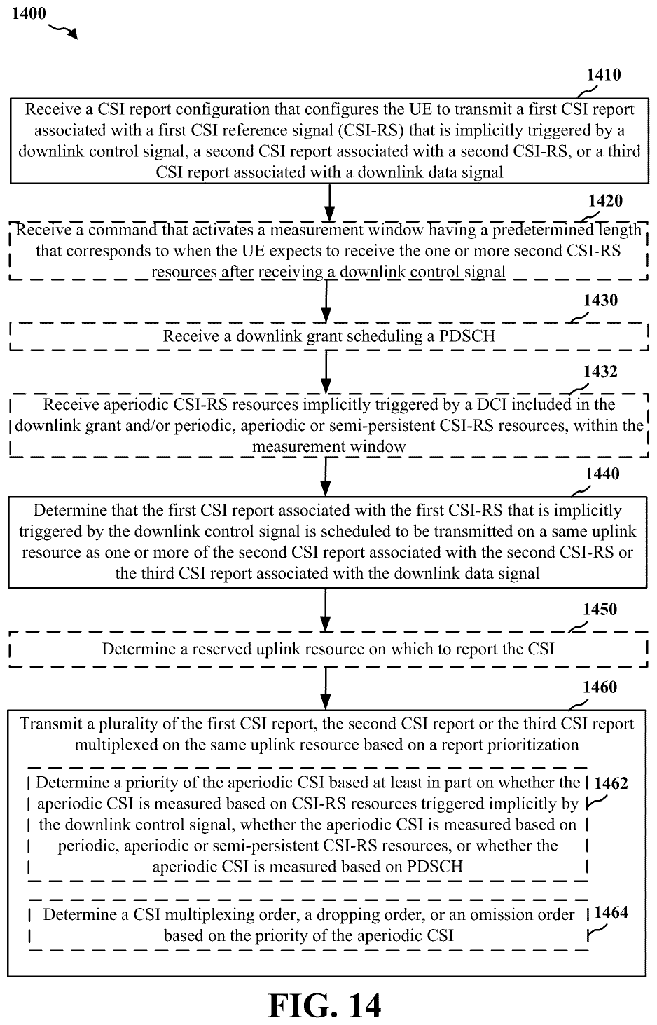

FIG. 14 is a flowchart of an example method 1400 for a UE report CSI. The method 1400 may be performed by a UE (such as the UE 104, which may include the memory 360 and which may be the entire UE 104 or a component of the UE 104 such as the CSI Tx component 140, TX processor 368, the RX processor 356, or the controller/processor 359). The method 1400 may be performed by the CSI Tx component 140 in communication with the CSI Rx component 120 of the base station 102. Optional blocks are shown with dashed lines.

At block 1410, the method 1400 may include receiving a CSI report configuration that configures the UE to transmit a first CSI report associated with a first CSI-RS that is implicitly triggered by a downlink control signal, a second CSI report associated with a second CSI-RS, or a third CSI report associated with a downlink data signal. In some implementations, for example, the UE 104, the RX processor 356 or the controller/processor 359 may execute the CSI Tx component 140 or the configuration component 141 to receive, via transceiver 354, the CSI report configuration that configures the UE 104 to report the CSI based on periodic, aperiodic or semi-persistent CSI-RS 1166, the PDSCH 1162 or the CSI-RS 1164 implicitly triggered by the DCI (from the downlink grant 1160). Accordingly, the UE 104, the RX processor 356, or the controller/processor 359 executing the CSI Tx component 140 or the configuration component 141 may provide means for receiving a CSI report configuration that configures the UE to transmit a first CSI report associated with a first CSI-RS that is implicitly triggered by a downlink control signal, a second CSI report associated with a second CSI-RS, or a third CSI report associated with a downlink data signal.

In some aspects, the UE 104 can receive a RRC configuration that configures one or more of uplink resources, one or more measurement resources for receiving the second CSI-RS, a first time measurement between the first CSI-RS and the downlink control signal, a second time measurement between the first CSI-RS and a transmission of the plurality of CSI reports, or a third time measurement between the downlink control signal and the transmission of at least one of the plurality of the first CSI report, the second CSI report or the third CSI report.

In some aspects, the CSI report configuration indicates that the UE is configured to transmit both the first CSI report based on the first CSI-RS implicitly triggered by the downlink control signal and the second CSI report based on the second CSI-RS, on the same uplink resource.

In some aspects, the CSI report configuration indicates that the UE is scheduled to transmit, when the particular CSI report trigger event occurs, a CSI report based on a report configuration identifier corresponding to one of the first CSI-RS or the second CSI-RS that is received last in time at the UE. In this regard, the UE 104 may measure channel state information based on the second CSI-RS, which is received subsequent to the first CSI-RS.

In some aspects, the CSI report configuration indicates that the UE is scheduled to transmit, when the particular CSI report trigger event occurs, an A-CSI report for each of a plurality of report configuration identifiers based on the UE configured to support sending the plurality of the first CSI report, the second CSI report or the third CSI report associated with respective ones of the plurality of report configuration identifiers within a same time interval. In some implementations, the CSI report configuration indicates that the UE is scheduled to transmit a separate report for each of the plurality of report configuration identifiers. In other implementations, the CSI report configuration configures the UE to transmit the first CSI report associated with the first CSI-RS implicitly triggered by the downlink control signal prior to the second CSI report associated with the second CSI-RS based on the first CSI report having a higher priority than the second CSI report. In some implementations, the CSI report configuration configures the UE to transmit the second CSI report associated with the second CSI-RS prior to the first CSI report associated with the first CSI-RS implicitly triggered by the downlink control signal based on the second CSI report having a higher priority than the first CSI report. In some implementations, the CSI report configuration configures the UE to prioritize between the first CSI report and the second CSI report based on which of the first CSI-RS and the second CSI-RS is received at the UE first in time. In other implementations, the CSI report configuration configures the UE to prioritize between the first CSI report and the second CSI report based on which of the first CSI-RS and the second CSI-RS is received at the UE last in time. In some implementations, the CSI report configuration configures the UE to merge the plurality of the first CSI report, the second CSI report or the third CSI report together into a merged CSI report by using measurements based on a channel resource indication as if the merged CSI report is associated with a single resource having a plurality of CSI-RS resources. In some aspects, the CSI report configuration indicates that the UE is scheduled to transmit the merged CSI report indicating a corresponding report configuration identifier and corresponding CSI measurements.

In some aspects, the CSI report configuration indicates that the UE is scheduled to transmit, when the particular CSI report trigger event occurs, one of the first CSI or the second CSI report based on a report configuration identifier that corresponds to one of the first CSI-RS or the second CSI-RS that is received at the UE first in time. In some aspects, the CSI report configuration indicates that the UE is scheduled to drop, when the particular CSI report trigger event occurs, the first CSI report associated with the first CSI-RS relative to the second CSI report associated with the second CSI-RS. In some implementations, the CSI report configuration configures the UE to prioritize the second CSI-RS over the first CSI-RS implicitly triggered by the downlink control signal.

In some aspects, the UE 104 may transmit, via the transceiver 354, hybrid automatic repeat request (HARQ) feedback on the uplink resource common with the CSI report. In some implementations, the HARQ feedback is transmitted in a first-stage uplink control information (UCI) and one or more CSI reports are transmitted in a second-stage UCI. For example, the first-stage UCI indicates a report configuration identifier that corresponds to measurements associated with a merged CSI report. In some implementations, the CSI report configuration configures the UE to indicate a type of CSI report as part of the HARQ feedback in the first-stage UCI.

In some aspects, the CSI report configuration indicates that the UE is scheduled to drop, when the particular CSI report trigger event occurs, the second CSI report associated with the second CSI-RS relative to the first CSI report associated with the first CSI-RS. In some implementations, the CSI report configuration configures the UE to prioritize the first CSI-RS implicitly triggered by the downlink control signal over the second CSI-RS.

At block 1420, the method 1400 may include receiving a command that activates a measurement window having a predetermined length that corresponds to when the UE expects to receive the first CSI-RS after receiving the downlink control signal. In some implementations, for example, the UE 104, the RX processor 356 or the controller/processor 359 may execute the CSI Tx component 140 or the activation component 142 to receive, via transceiver 354, a command (e.g., activation/deactivation command 1120) that activates a measurement window having a predetermined length that corresponds to when the UE 104 expects to receive the first CSI-RS after receiving the downlink control signal. In some implementations, the command is a MAC-CE. In some aspects, the predetermined length of the measurement window is configured via a RRC configuration or the MAC-CE. In some implementations, the aperiodic CSI reporting based on the CSI-RS 1164 or the CSI-RS 1166 remains active until a deactivation command is received. For example, the measurement window having the predetermined length can be activated via a first MAC-CE and deactivated via a second MAC-CE. In some implementations, the CSI reporting based on the CSI-RS 1164 or the CSI-RS 1166 remains active for a number of CSI transmission opportunities. For instance, the number of CSI transmission opportunities may be defined by an RRC configuration message or defined in a standards document or regulation. Accordingly, the UE 104, the RX processor 356, or the controller/processor 359 executing the CSI Tx component 140 or the activation component 142 may provide means for receiving a command that activates a measurement window having a predetermined length that corresponds to when the UE expects to receive the first CSI-RS after receiving the downlink control signal.

At block 1430, the method 1400 may include receiving a downlink grant scheduling a PDSCH. In some implementations, for example, the UE 104, the RX processor 356 or the controller/processor 359 may execute the CSI Tx component 140 or the grant component 143 to receive, via transceiver 354, the downlink grant 1160 scheduling the PDSCH 1162. Accordingly, the UE 104, the RX processor 356, or the controller/processor 359 executing the CSI Tx component 140 or the grant component 143 may provide means for receiving a downlink grant scheduling a PDSCH. In some aspects, the downlink grant may include a downlink control signal, such as a DCI.

At block 1432, the method 1400 may include receiving aperiodic CSI-RS resources implicitly triggered by a DCI included in the downlink grant and/or periodic, aperiodic or semi-persistent CSI-RS resources, within the measurement window. In some implementations, for example, the UE 104, the RX processor 356 or the controller/processor 359 may execute the CSI Tx component 140 or the trigger component 144 to receive, via transceiver 354, the CSI-RS 1164 and/or the CSI-RS 1166, within the measurement window. Accordingly, the UE 104, the RX processor 356, or the controller/processor 359 executing the CSI Tx component 140 or the trigger component 144 may provide means for receiving aperiodic CSI-RS resources implicitly triggered by a DCI included in the downlink grant and/or periodic, aperiodic or semi-persistent CSI-RS resources, within the measurement window.

In some aspects, the UE 104 may obtain one or more measurements of received downlink signals on one or more measurement resources at the UE 104. In this regard, the 104 may determine one or more of a block error rate (BLER) or a bit error rate (BER) from the one or more measurements. In some aspects, the CSI report configuration configures the UE to transmit at least one of the plurality of the first CSI report, the second CSI report or the third CSI report based on one or more of an amount of interference indicated by the one or more measurements, the BLER or the BER.

At block 1440, the method 1400 may include determining that the first CSI report associated with the first CSI-RS that is implicitly triggered by the downlink control signal is scheduled to be transmitted on a same uplink resource as one or more of the second CSI report associated with the second CSI-RS or the third CSI report associated with the downlink data signal. In some aspects, the UE may determine there is a potential collision between the first CSI report associated with the first CSI-RS implicitly triggered by the DCI and at least one of the second CSI report associated with the second CSI-RS or the third CSI report associated with the PDSCH. In some implementations, for example, the UE 104, the TX processor 368 or the controller/processor 359 may execute the CSI Tx component 140 or the trigger component 144 to determine to report a CSI (e.g., CSI report 1168) in response to a measurement of a downlink measurement resource, a measurement of the PDSCH, or in response to the downlink grant 1160 requesting the CSI. Accordingly, the UE 104, the TX processor 368, or the controller/processor 359 executing the CSI Tx component 140 or the trigger component 144 may provide means for determining that the first CSI report associated with the first CSI-RS that is implicitly triggered by the downlink control signal is scheduled to be transmitted on a same uplink resource as one or more of the second CSI report associated with the second CSI-RS or the third CSI report associated with the downlink data signal.

In some aspects, the UE 104 may monitor for a particular CSI report trigger event to occur by determining whether the CSI report configuration indicates that a first report configuration identifier associated with the first CSI-RS implicitly triggered by the downlink control signal and a second report configuration identifier associated with the second CSI-RS are scheduled to use same uplink resources. In some examples, the second CSI-RS corresponds to one of an aperiodic CSI-RS, a periodic CSI-RS or a semi-persistent CSI-RS.

In some aspects, the CSI report configuration configures the UE to transmit the second CSI report associated with the second CSI-RS with a length of Y bits. In some implementations, the CSI report configuration configures the UE to transmit the third CSI report associated with the downlink data signal with a length of X bits. In some aspects, the CSI report configuration configures the UE to transmit the third CSI report associated with the downlink data signal along with different CSI content measured based on the first CSI-RS or the second CSI-RS with a length of X+Y′, where Y′<Y bits. In other aspects, the CSI report configuration configures the UE to merge the second CSI report associated with the second CSI-RS and the third CSI report associated with the downlink data signal into a merged CSI report with a total length of X+Y bits.

At block 1450, the method 1400 may include determining a reserved uplink resource on which to report the CSI. In some implementations, for example, the UE 104, the TX processor 368 or the controller/processor 359 may execute the CSI Tx component 140 or the resource component 146 to determine a reserved uplink resource on which to report the CSI. In some implementations, the reserved uplink resource includes a PUCCH resource or a PUSCH resource selected from a list of reserved PUSCH resources or PUCCH resources configured by a RRC message. The selection may be determined based on an indication received in a DCI or a RRC message or based on a report ID, resource ID, or HARQ process number. In some implementations, reserved uplink resource includes a dedicated SR resource according to a periodicity and offset. In some implementations, the reserved uplink resource further includes a PUCCH resource defined by an offset from the dedicated SR. In some implementations, the reserved uplink resource is a dedicated two-step random access resource. The CSI may be carried in a msgA payload on a physical uplink PUSCH portion of the two-step random access resource. Accordingly, the UE 104, the TX processor 368, or the controller/processor 359 executing the CSI Tx component 140 or the resource component 146 may provide means for determining a reserved uplink resource on which to report the aperiodic CSI.

At block 1460, the method 1400 may include transmitting a plurality of the first CSI report, the second CSI report or the third CSI report multiplexed on the same uplink resource based on a report prioritization. In some implementations, for example, the UE 104, the RX processor 356 or the controller/processor 359 may execute the CSI Tx component 140 or the report component 147 to transmit, via transceiver 354, one or more CSI reports 1168 on the reserved uplink resource. In some aspects, the CSI report configuration configures the UE to select one of the plurality of the first CSI report, the second CSI report or the third CSI report when the plurality of the first CSI report, the second CSI report or the third CSI report have similar CSI content and to generate a final CSI report with a corresponding payload of a selected CSI report.

In some implementations, at sub-block 1462, the block 1460 may include determining a priority of the CSI based at least in part on whether the CSI is measured based on the first CSI-RS triggered implicitly by the downlink control signal, whether the CSI is measured based on periodic, aperiodic or semi-persistent CSI-RS, or whether the CSI is measured based on PDSCH. In some aspects, the UE 104 may prioritize between the first CSI report associated with the first CSI-RS and the second CSI report associated with the second CSI-RS based on corresponding report configuration identifiers.

In some implementations, at sub-block 1464, the block 1460 may include determining a CSI multiplexing order, a dropping order, or an omission order based on the priority of the aperiodic CSI. Accordingly, the UE 104, the RX processor 356, or the controller/processor 359 executing the CSI Tx component 140 or the report component 147 may provide means for transmitting a plurality of the first CSI report, the second CSI report or the third CSI report multiplexed on the same uplink resource based on a report prioritization. In some aspects, the UE 104 may multiplex and transmit the plurality of the first CSI report, the second CSI report and/or the third CSI report on a same PUCCH resource.

In some aspects, the CSI report configuration configures the UE 104 to order report configuration identifiers based on timing of corresponding CSI-RS resources within a resource set and to indicate a new index corresponding to an ordered report configuration ID. In some aspects, the CSI report configuration indicates that the UE is to report each of the first CSI report based on the first CSI-RS implicitly triggered by the downlink control signal, the second CSI report based on the second CSI-RS and the third CSI report based on the downlink data signal.

In some implementations, the CSI report configuration indicates that the third CSI report associated with the downlink data signal has a periodicity and is scheduled to at least partially overlap with an activation of the first CSI report measured based on the first CSI-RS implicitly triggered by the downlink control signal. In other implementations, the CSI report configuration indicates that the third CSI report associated with the downlink data signal and the first CSI report associated with the first CSI-RS implicitly triggered by the downlink control signal are to activate concurrently for at least a portion of a measurement window. In some aspects. In some aspects, the first CSI report and the third CSI report are multiplexed and transmitted on a same PUCCH resource.

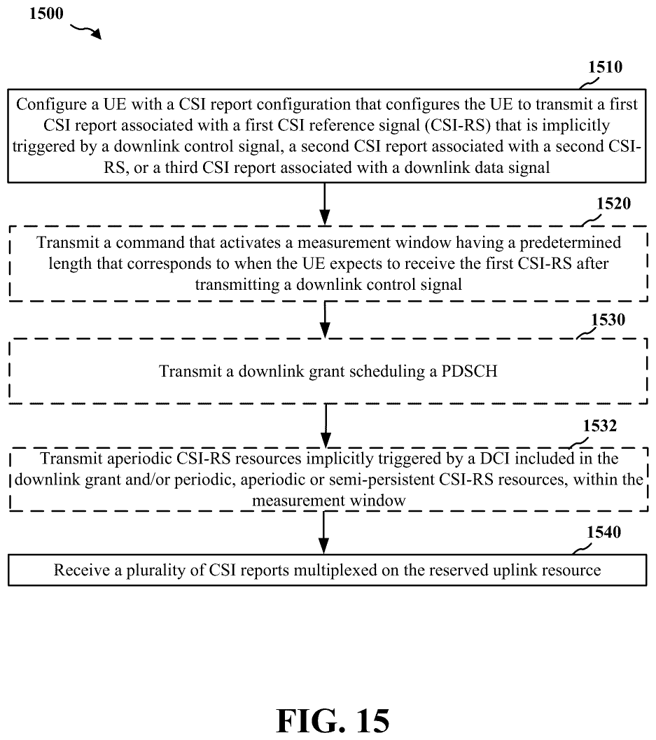

FIG. 15 is a flowchart of an example method 1500 for a base station to receive a CSI-RS based CSI report or a downlink grant based CSI report. The method 1500 may be performed by a base station (such as the base station 102, which may include the memory 376 and which may be the entire base station 102 or a component of the base station 102 such as the CSI Rx component 120, TX processor 156, the RX processor 370, or the controller/processor 375). The method 1500 may be performed by the CSI Rx component 120 in communication with the CSI Tx component 140 of the UE 104.

At block 1510, the method 1500 may include configuring a UE with a CSI report configuration that configures the UE to transmit a first CSI report associated with a first CSI-RS that is implicitly triggered by a downlink control signal, a second CSI report associated with a second CSI-RS, or a third CSI report associated with a downlink data signal. In some implementations, for example, the base station 102, the controller/processor 375, or the TX processor 156 may execute the CSI Rx component 120 or the configuration component 122 to configure a UE with a CSI report configuration that configures the UE to transmit a first CSI report associated with a first CSI-RS that is implicitly triggered by a downlink control signal, a second CSI report associated with a second CSI-RS, or a third CSI report associated with a downlink data signal. Accordingly, the base station 102, the controller/processor 375, or the TX processor 156 executing the CSI Rx component 120 or the configuration component 122 may provide means for configuring a UE with a CSI report configuration that configures the UE to transmit a first CSI report associated with a first CSI-RS that is implicitly triggered by a downlink control signal, a second CSI report associated with a second CSI-RS, or a third CSI report associated with a downlink data signal.

At block 1520, the method 1500 may optionally include transmitting a command that activates a measurement window having a predetermined length that corresponds to when the UE expects to receive the first CSI-RS after transmitting the downlink control signal. In some aspects, the predetermined length of the measurement window is configured via a radio resource control (RRC) configuration or the MAC-CE. In some implementations, for example, the base station 102, the controller/processor 375, or the TX processor 156 may execute the CSI Rx component 120 or the activation component 123 to transmit, via transceiver 354, a command that activates a measurement window having a predetermined length that corresponds to when the UE expects to receive the first CSI-RS after transmitting the downlink control signal. Accordingly, the base station 102, the controller/processor 375, or the TX processor 156 executing the CSI Rx component 120 or the activation component 123 may provide means for transmitting a command that activates a measurement window having a predetermined length that corresponds to when the UE expects to receive the first CSI-RS after transmitting the downlink control signal.

At block 1530, the method 1500 may include transmitting a downlink grant scheduling a PDSCH. In some implementations, for example, the base station 102, the controller/processor 375, or the TX processor 156 may execute the CSI Rx component 120 or the scheduling component 124 to transmit, via transceiver 318, a downlink grant scheduling a PDSCH. Accordingly, the base station 102, the controller/processor 375, or the TX processor 156 executing the CSI Rx component 120 or the scheduling component 124 may provide means for transmitting a downlink grant scheduling a PDSCH.

At block 1532, the method 1500 may include transmitting an aperiodic CSI-RS that is associated with the first CSI report that is implicitly triggered by a DCI included in the downlink grant and/or transmit periodic CSI-RS, an aperiodic CSI-RS or a semi-persistent CSI-RS, within the measurement window. In some implementations, for example, the base station 102, the controller/processor 375, or the TX processor 156 may execute the CSI Rx component 120 or the scheduling component 124 to transmit, via transceiver 318, the CSI-RS 1164 and/or the CSI-RS 1166, within the measurement window. Accordingly, the base station 102, the controller/processor 375, or the TX processor 156 executing the CSI Rx component 120 or the scheduling component 124 may provide means for transmitting an aperiodic CSI-RS that is associated with the first CSI report that is implicitly triggered by a DCI included in the downlink grant and/or transmit periodic CSI-RS, an aperiodic CSI-RS or a semi-persistent CSI-RS, within the measurement window.

At block 1540, the method 1500 may include receiving plurality of CSI reports multiplexed on the reserved uplink resource. In some implementations, for example, the base station 102, the controller/processor 375, or the TX processor 156 may execute the CSI Rx component 120 or the report receiving component 126 to receive, via transceiver 318, a multiplex of plural CSI reports on the reserved uplink resource. Accordingly, the base station 102, the controller/processor 375, or the TX processor 156 executing the CSI Rx component 120 or the report receiving component 126 may provide means for receiving a plurality of CSI reports multiplexed on the reserved uplink resource.

The following examples are illustrative only and may be combined with aspects of other embodiments or teachings described herein, without limitation.

Example 1 is an apparatus of wireless communication at a user equipment that includes at least one processor; a transceiver; and a memory, coupled to the at least one processor and the transceiver, storing instructions thereon, which when executed by the at least one processor, cause the apparatus to receive, from a base station, via the transceiver, a channel state information (CSI) report configuration that configures the UE to transmit a first CSI report associated with a first CSI reference signal (CSI-RS) that is implicitly triggered by a downlink control signal, a second CSI report associated with a second CSI-RS, or a third CSI report associated with a downlink data signal; determine that the first CSI report associated with the first CSI-RS that is implicitly triggered by the downlink control signal is scheduled to be transmitted on a same uplink resource as one or more of the second CSI report associated with the second CSI-RS or the third CSI report associated with the downlink data signal; and transmit, via the transceiver, a plurality of the first CSI report, the second CSI report or the third CSI report multiplexed on the same uplink resource based on a report prioritization.

In Example 2, the apparatus of Example 1 further includes that the instructions, which when executed by the at least one processor, further cause the apparatus to receive, via the transceiver, a medium access control (MAC) control element (MAC-CE) comprising a command that activates a measurement window having a predetermined length that corresponds to when the UE expects to receive the first CSI-RS after receiving the downlink control signal, wherein the predetermined length of the measurement window is configured via a radio resource control (RRC) configuration or the MAC-CE.

In Example 3, the apparatus of Example 2 further includes that the measurement window having the predetermined length is activated via a first MAC-CE and deactivated via a second MAC-CE.

In Example 4, the apparatus of any of Examples 1-3, wherein the instructions, which when executed by the at least one processor, further cause the apparatus to receive, via the transceiver, a radio resource control (RRC) configuration that configures one or more of uplink resources, the first CSI-RS, a first time measurement between the second CSI-RS and the downlink control signal, a second time measurement between the second CSI-RS and a transmission of at least one of the plurality of the first CSI report, the second CSI report or the third CSI report, or a third time measurement between the downlink control signal and the transmission of the at least one of the plurality of the first CSI report, the second CSI report or the third CSI report.

In Example 5, the apparatus of any of Examples 1-4 further includes that the instructions, which when executed by the at least one processor, further cause the apparatus to receive, via the transceiver, a downlink grant scheduling the downlink data signal, wherein the downlink data signal comprises a physical downlink shared channel (PDSCH).

In Example 6, the apparatus of Example 5 further includes that to receive the downlink grant comprises to receive the downlink control signal, wherein the downlink control signal comprises a downlink control information (DCI) message.

In Example 7, the apparatus of any of Examples 1-6 further includes that the CSI report configuration indicates that the UE is configured to transmit both the first CSI report based on the first CSI-RS implicitly triggered by the downlink control signal and the second CSI report based on the second CSI-RS on the same uplink resource.

In Example 8, the apparatus of Example 7 further includes that the instructions, which when executed by the at least one processor, further cause the apparatus to prioritize between the first CSI report associated with the first CSI-RS and the second CSI report associated with the second CSI-RS based on corresponding report configuration identifiers.

In Example 9, the apparatus of any of Examples 1-8 further includes that the plurality of the first CSI report, the second CSI report or the third CSI report are multiplexed and transmitted on a same physical uplink control channel (PUCCH) resource.

In Example 10, the apparatus of any of Examples 1-9 further includes that the instructions, which when executed by the at least one processor, further cause the apparatus to monitor for a particular CSI report trigger event to occur by determining whether the CSI report configuration indicates that a first report configuration identifier associated with the first CSI-RS implicitly triggered by the downlink control signal and a second report configuration identifier associated with the second CSI-RS are scheduled to use same uplink resources, wherein the second CSI-RS corresponds to one of an aperiodic CSI-RS, a periodic CSI-RS or a semi-persistent CSI-RS.

In Example 11, the apparatus of Example 10 further includes that the CSI report configuration indicates that the UE is to transmit, when the particular CSI report trigger event occurs, a CSI report based on a report configuration identifier corresponding to one of the first CSI-RS or the second CSI-RS that is received last in time at the UE.

In Example 12, the apparatus of Example 11 further includes that the instructions, which when executed by the at least one processor, further cause the apparatus to measure channel state information based on the second CSI-RS, wherein the second CSI-RS is received subsequent to the first CSI-RS.

In Example 13, the apparatus of Example 10 further includes that the CSI report configuration indicates that the UE is to transmit, when the particular CSI report trigger event occurs, a CSI report for each of a plurality of report configuration identifiers based on the UE configured to support sending the plurality of the first CSI report, the second CSI report or the third CSI report associated with respective ones of the plurality of report configuration identifiers within a same time interval.

In Example 14, the apparatus of Example 13 further includes that the CSI report configuration indicates that the UE is to transmit a separate report for each of the plurality of report configuration identifiers.

In Example 15, the apparatus of Example 13 further includes that the CSI report configuration configures the UE to transmit the first CSI report associated with the first CSI-RS implicitly triggered by the downlink control signal prior to the second CSI report associated with the second CSI-RS based on the first CSI report having a higher priority than the second CSI report.

In Example 16, the apparatus of Example 13 further includes that the CSI report configuration configures the UE to transmit the second CSI report associated with the second CSI-RS prior to the first CSI report associated with the first CSI-RS implicitly triggered by the downlink control signal based on the second CSI report having a higher priority than the first CSI report.

In Example 17, the apparatus of Example 13 further includes that the CSI report configuration configures the UE to prioritize between the first CSI report and the second CSI report based on which of the first CSI-RS and the second CSI-RS is received at the UE first in time.

In Example 18, the apparatus of Example 13 further includes that the CSI report configuration configures the UE to prioritize between the first CSI report and the second CSI report based on which of the first CSI-RS and the second CSI-RS is received at the UE last in time.

In Example 19, the apparatus of Example 13 further includes that the CSI report configuration configures the UE to merge the plurality of the first CSI report, the second CSI report or the third CSI report together into a merged CSI report by using measurements based on a channel resource indication as if the merged CSI report is associated with a single resource having a plurality of CSI-RS resources, wherein the CSI report configuration indicates that the UE is to transmit the merged CSI report indicating a corresponding report configuration identifier and corresponding CSI measurements.

In Example 20, the apparatus of Example 10 further includes that the CSI report configuration indicates that the UE is to transmit, when the particular CSI report trigger event occurs, one of the first CSI or the second CSI report based on a report configuration identifier that corresponds to one of the first CSI-RS or the second CSI-RS that is received at the UE first in time.

In Example 21, the apparatus of Example 10 further includes that the CSI report configuration indicates that the UE is to drop, when the particular CSI report trigger event occurs, the first CSI report associated with the first CSI-RS relative to the second CSI report associated with the second CSI-RS, wherein the CSI report configuration configures the UE to prioritize the second CSI-RS over the first CSI-RS implicitly triggered by the downlink control signal.

In Example 22, the apparatus of Example 10 further includes that the CSI report configuration indicates that the UE is to drop, when the particular CSI report trigger event occurs, the second CSI report associated with the second CSI-RS relative to the first CSI report associated with the first CSI-RS, wherein the CSI report configuration configures the UE to prioritize the first CSI-RS implicitly triggered by the downlink control signal over the second CSI-RS.

In Example 23, the apparatus of any of Examples 1-22 further includes that the instructions, which when executed by the at least one processor, further cause the apparatus to transmit, via the transceiver, hybrid automatic repeat request (HARQ) feedback and at least one of the plurality of the first CSI report, the second CSI report or the third CSI report on the same uplink resource, wherein the HARQ feedback is transmitted in a first-stage uplink control information (UCI) and the at least one of the plurality of the first CSI report, the second CSI report or the third CSI report is transmitted in a second-stage UCI.

In Example 24, the apparatus of Example 23 further includes that the first-stage UCI indicates a report configuration identifier that corresponds to measurements associated with a merged CSI report.

In Example 25, the apparatus of any of Examples 1-24 further includes that the CSI report configuration configures the UE to order report configuration identifiers based on timing of corresponding CSI-RS resources within a resource set and to indicate a new index corresponding to an ordered report configuration ID.

In Example 26, the apparatus of any of Examples 1-25 further includes that the CSI report configuration indicates that the UE is to report each of the first CSI report based on the first CSI-RS implicitly triggered by the downlink control signal, the second CSI report based on the second CSI-RS and the third CSI report based on the downlink data signal.

In Example 27, the apparatus of any of Examples 1-26 further includes that the CSI report configuration indicates that the third CSI report associated with the downlink data signal has a periodicity and is scheduled to at least partially overlap with an activation of the first CSI report measured based on the first CSI-RS implicitly triggered by the downlink control signal, wherein the first CSI report and the third CSI report are multiplexed and transmitted on a same physical uplink control channel (PUCCH) resource.

In Example 28, the apparatus of any of Examples 1-27 further includes that the CSI report configuration indicates that the third CSI report associated with the downlink data signal and the first CSI report associated with the first CSI-RS implicitly triggered by the downlink control signal are to activate concurrently for at least a portion of a measurement window, wherein the first CSI report and the third CSI report are multiplexed and transmitted on a same physical uplink control channel (PUCCH) resource.

In Example 29, the apparatus of any of Examples 1-28 further includes that the instructions, which when executed by the at least one processor, further cause the apparatus to obtain one or more measurements of received downlink signals at the UE; and determine one or more of a block error rate (BLER) or a bit error rate (BER) from the one or more measurements, wherein the CSI report configuration configures the UE to transmit at least one of the plurality of the first CSI report, the second CSI report or the third CSI report based on one or more of an amount of interference indicated by the one or more measurements, the BLER or the BER.

In Example 30, the apparatus of any of Examples 1-29 further includes that the CSI report configuration configures the UE to transmit the second CSI report associated with the second CSI-RS with a length of Y bits, wherein the CSI report configuration configures the UE to transmit the third CSI report associated with the downlink data signal with a length of X bits.

In Example 31, the apparatus of Example 30 further includes that the CSI report configuration configures the UE to transmit the third CSI report associated with the downlink data signal along with different CSI content measured based on the first CSI-RS or the second CSI-RS with a length of X+Y′, where Y′<Y bits.

In Example 32, the apparatus of Example 30 further includes that the CSI report configuration configures the UE to merge the second CSI report associated with the second CSI-RS and the third CSI report associated with the downlink data signal into a merged CSI report with a total length of X+Y bits.

In Example 33, the apparatus of any of Examples 1-32 further includes that the CSI report configuration configures the UE to select one of the plurality of the first CSI report, the second CSI report or the third CSI report when the plurality of the first CSI report, the second CSI report or the third CSI report have similar CSI content and to generate a final CSI report with a corresponding payload of a selected CSI report.

In Example 34, the apparatus of any of Examples 1-33 further includes that the instructions, which when executed by the at least one processor, further cause the apparatus to transmit, via the transceiver, hybrid automatic repeat request (HARQ) feedback and at least one of the plurality of the first CSI report, the second CSI report or the third CSI report on the same uplink resource, wherein the HARQ feedback is transmitted in a first-stage uplink control information (UCI) and the at least one of the plurality of the first CSI report, the second CSI report or the third CSI report is transmitted in a second-stage UCI, wherein the CSI report configuration configures the UE to indicate a type of CSI report as part of the HARQ feedback in the first-stage UCI.

Example 35 is a device including one or more processors and one or more memories in electronic communication with the one or more processors storing instructions executable by the one or more processors to cause a system or a method to realize an apparatus as in any of Examples 1 to 34.

Example 36 is a system or method including means for realizing an apparatus as in any of Examples 1 to 34.

Example 37 is a non-transitory computer-readable medium storing instructions executable by one or more processors to cause the one or more processors to realize an apparatus as in any of Examples 1 to 34.

Example 38 is an apparatus of wireless communication at a base station that includes at least one processor; a transceiver; and a memory, coupled to the at least one processor and the transceiver, storing instructions thereon, which when executed by the at least one processor, cause the apparatus to transmit, to a user equipment (UE), via the transceiver, a channel state information (CSI) report configuration that configures the UE to transmit a first CSI report associated with a first CSI reference signal (CSI-RS) that is implicitly triggered by a downlink control signal, a second CSI report associated with a second CSI-RS, or a third CSI report associated with a downlink data signal; and receive, from the UE, via the transceiver, a plurality of the first CSI report, the second CSI report or the third CSI report multiplexed on the same uplink resource based on a report prioritization, wherein the first CSI report associated with the first CSI-RS that is implicitly triggered by the downlink control signal is received on a same uplink resource as one or more of the second CSI report associated with the second CSI-RS or the third CSI report associated with the downlink data signal.

Example 39 is a device including one or more processors and one or more memories in electronic communication with the one or more processors storing instructions executable by the one or more processors to cause a system or a method to realize an apparatus as in Example 38.

Example 40 is a system or method including means for realizing an apparatus as in Example 38.

Example 41 is a non-transitory computer-readable medium storing instructions executable by one or more processors to cause the one or more processors to realize an apparatus as in Example 38.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An apparatus for wireless communication at a user equipment (UE), the apparatus comprising:
at least one processor;
a transceiver; and
a memory, coupled to the at least one processor and the transceiver, storing instructions thereon, which when executed by the at least one processor, cause the apparatus to:
receive, from a base station, via the transceiver, a channel state information (CSI) report configuration that configures the UE to transmit a first CSI report associated with a first CSI reference signal (CSI-RS) that is implicitly triggered by a downlink control signal, a second CSI report associated with a second CSI-RS, or a third CSI report associated with a downlink data signal;
determine that the first CSI report associated with the first CSI-RS that is implicitly triggered by the downlink control signal is scheduled to be transmitted on a same uplink resource as one or more of the second CSI report associated with the second CSI-RS or the third CSI report associated with the downlink data signal; and
transmit, via the transceiver, a plurality of the first CSI report, the second CSI report or the third CSI report multiplexed on the same uplink resource based on a report prioritization.

2. The apparatus of claim 1, wherein the instructions, which when executed by the at least one processor, further cause the apparatus to receive, via the transceiver, a medium access control (MAC) control element (MAC-CE) comprising a command that activates a measurement window having a predetermined length that corresponds to when the UE expects to receive the first CSI-RS after receiving the downlink control signal, wherein the predetermined length of the measurement window is configured via a radio resource control (RRC) configuration or the MAC-CE.

3. The apparatus of claim 2, wherein the measurement window having the predetermined length is activated via a first MAC-CE and deactivated via a second MAC-CE.

4. The apparatus of claim 1, wherein the instructions, which when executed by the at least one processor, further cause the apparatus to receive, via the transceiver, a radio resource control (RRC) configuration that configures one or more of uplink resources, the first CSI-RS, a first time measurement between the second CSI-RS and the downlink control signal, a second time measurement between the second CSI-RS and a transmission of at least one of the plurality of the first CSI report, the second CSI report or the third CSI report, or a third time measurement between the downlink control signal and the transmission of the at least one of the plurality of the first CSI report, the second CSI report or the third CSI report.

5. The apparatus of claim 1, wherein the instructions, which when executed by the at least one processor, further cause the apparatus to receive, via the transceiver, a downlink grant scheduling the downlink data signal, wherein the downlink data signal comprises a physical downlink shared channel (PDSCH).

6. The apparatus of claim 5, wherein to receive the downlink grant comprises to receive the downlink control signal, wherein the downlink control signal comprises a downlink control information (DCI) message.

7. The apparatus of claim 1, wherein the CSI report configuration indicates that the UE is configured to transmit both the first CSI report based on the first CSI-RS implicitly triggered by the downlink control signal and the second CSI report based on the second CSI-RS on the same uplink resource.

8. The apparatus of claim 7, wherein the instructions, which when executed by the at least one processor, further cause the apparatus to prioritize between the first CSI report associated with the first CSI-RS and the second CSI report associated with the second CSI-RS based on corresponding report configuration identifiers.

9. The apparatus of claim 1, wherein the instructions, which when executed by the at least one processor, further cause the apparatus to monitor for a particular CSI report trigger event to occur by determining whether the CSI report configuration indicates that a first report configuration identifier associated with the first CSI-RS implicitly triggered by the downlink control signal and a second report configuration identifier associated with the second CSI-RS are scheduled to use same uplink resources, wherein the second CSI-RS corresponds to one of an aperiodic CSI-RS, a periodic CSI-RS or a semi-persistent CSI-RS.

10. The apparatus of claim 9, wherein the CSI report configuration indicates that the UE is to transmit, when the particular CSI report trigger event occurs, a CSI report based on a report configuration identifier corresponding to one of the first CSI-RS or the second CSI-RS that is received last in time at the UE.

11. The apparatus of claim 10, wherein the instructions, which when executed by the at least one processor, further cause the apparatus to measure channel state information based on the second CSI-RS, wherein the second CSI-RS is received subsequent to the first CSI-RS.

12. The apparatus of claim 9, wherein the CSI report configuration indicates that the UE is to transmit, when the particular CSI report trigger event occurs, a CSI report for each of a plurality of report configuration identifiers based on the UE configured to support sending the plurality of the first CSI report, the second CSI report or the third CSI report associated with respective ones of the plurality of report configuration identifiers within a same time interval.

13. The apparatus of claim 12, wherein the CSI report configuration indicates that the UE is to transmit a separate report for each of the plurality of report configuration identifiers.

14. The apparatus of claim 12, wherein the CSI report configuration configures the UE to transmit the first CSI report associated with the first CSI-RS implicitly triggered by the downlink control signal prior to the second CSI report associated with the second CSI-RS based on the first CSI report having a higher priority than the second CSI report.

15. The apparatus of claim 12, wherein the CSI report configuration configures the UE to transmit the second CSI report associated with the second CSI-RS prior to the first CSI report associated with the first CSI-RS implicitly triggered by the downlink control signal based on the second CSI report having a higher priority than the first CSI report.

16. The apparatus of claim 12, wherein the CSI report configuration configures the UE to prioritize between the first CSI report and the second CSI report based on which of the first CSI-RS and the second CSI-RS is received at the UE first in time.

17. The apparatus of claim 12, wherein the CSI report configuration configures the UE to prioritize between the first CSI report and the second CSI report based on which of the first CSI-RS and the second CSI-RS is received at the UE last in time.

18. The apparatus of claim 12, wherein the CSI report configuration configures the UE to merge the plurality of the first CSI report, the second CSI report or the third CSI report together into a merged CSI report by using measurements based on a channel resource indication as if the merged CSI report is associated with a single resource having a plurality of CSI-RS resources, wherein the CSI report configuration indicates that the UE is to transmit the merged CSI report indicating a corresponding report configuration identifier and corresponding CSI measurements.

19. The apparatus of claim 9, wherein the CSI report configuration indicates that the UE is to transmit, when the particular CSI report trigger event occurs, one of the first CSI or the second CSI report based on a report configuration identifier that corresponds to one of the first CSI-RS or the second CSI-RS that is received at the UE first in time.

20. The apparatus of claim 9, wherein the CSI report configuration indicates that the UE is to drop, when the particular CSI report trigger event occurs, the first CSI report associated with the first CSI-RS relative to the second CSI report associated with the second CSI-RS, wherein the CSI report configuration configures the UE to prioritize the second CSI-RS over the first CSI-RS implicitly triggered by the downlink control signal.

21. The apparatus of claim 9, wherein the CSI report configuration indicates that the UE is to drop, when the particular CSI report trigger event occurs, the second CSI report associated with the second CSI-RS relative to the first CSI report associated with the first CSI-RS, wherein the CSI report configuration configures the UE to prioritize the first CSI-RS implicitly triggered by the downlink control signal over the second CSI-RS.

22. The apparatus of claim 1, wherein the instructions, which when executed by the at least one processor, further cause the apparatus to transmit, via the transceiver, hybrid automatic repeat request (HARQ) feedback and at least one of the plurality of the first CSI report, the second CSI report or the third CSI report on the same uplink resource, wherein the HARQ feedback is transmitted in a first-stage uplink control information (UCI) and the at least one of the plurality of the first CSI report, the second CSI report or the third CSI report is transmitted in a second-stage UCI.

23. The apparatus of claim 22, wherein the first-stage UCI indicates a report configuration identifier that corresponds to measurements associated with a merged CSI report.

24. The apparatus of claim 1, wherein the CSI report configuration configures the UE to order report configuration identifiers based on timing of corresponding CSI-RS resources within a resource set and to indicate a new index corresponding to an ordered report configuration ID.

25. The apparatus of claim 1, wherein the CSI report configuration indicates that the UE is to report each of the first CSI report based on the first CSI-RS implicitly triggered by the downlink control signal, the second CSI report based on the second CSI-RS and the third CSI report based on the downlink data signal.

26. The apparatus of claim 1, wherein the CSI report configuration indicates that the third CSI report associated with the downlink data signal has a periodicity and is scheduled to at least partially overlap with an activation of the first CSI report measured based on the first CSI-RS implicitly triggered by the downlink control signal, wherein the first CSI report and the third CSI report are multiplexed and transmitted on a same physical uplink control channel (PUCCH) resource.

27. The apparatus of claim 1, wherein the CSI report configuration indicates that the third CSI report associated with the downlink data signal and the first CSI report associated with the first CSI-RS implicitly triggered by the downlink control signal are to activate concurrently for at least a portion of a measurement window, wherein the first CSI report and the third CSI report are multiplexed and transmitted on a same physical uplink control channel (PUCCH) resource.

28. The apparatus of claim 1, wherein the instructions, which when executed by the at least one processor, further cause the apparatus to:
obtain one or more measurements of received downlink signals at the UE; and
determine one or more of a block error rate (BLER) or a bit error rate (BER) from the one or more measurements, wherein the CSI report configuration configures the UE to transmit at least one of the plurality of the first CSI report, the second CSI report or the third CSI report based on one or more of an amount of interference indicated by the one or more measurements, the BLER or the BER.

29. The apparatus of claim 1, wherein the CSI report configuration configures the UE to transmit the second CSI report associated with the second CSI-RS with a length of Y bits, wherein the CSI report configuration configures the UE to transmit the third CSI report associated with the downlink data signal with a length of X bits.

30. The apparatus of claim 29, wherein the CSI report configuration configures the UE to transmit the third CSI report associated with the downlink data signal along with different CSI content measured based on the first CSI-RS or the second CSI-RS with a length of X+Y′, where Y′<Y bits.

31. The apparatus of claim 29, wherein the CSI report configuration configures the UE to merge the second CSI report associated with the second CSI-RS and the third CSI report associated with the downlink data signal into a merged CSI report with a total length of X+Y bits.

32. The apparatus of claim 1, wherein the CSI report configuration configures the UE to select one of the plurality of the first CSI report, the second CSI report or the third CSI report when the plurality of the first CSI report, the second CSI report or the third CSI report have similar CSI content and to generate a final CSI report with a corresponding payload of a selected CSI report.

33. The apparatus of claim 1, wherein the instructions, which when executed by the at least one processor, further cause the apparatus to transmit, via the transceiver, hybrid automatic repeat request (HARQ) feedback and at least one of the plurality of the first CSI report, the second CSI report or the third CSI report on the same uplink resource, wherein the HARQ feedback is transmitted in a first-stage uplink control information (UCI) and the at least one of the plurality of the first CSI report, the second CSI report or the third CSI report is transmitted in a second-stage UCI, wherein the CSI report configuration configures the UE to indicate a type of CSI report as part of the HARQ feedback in the first-stage UCI.

34. A method of wireless communication performed by a user equipment (UE), the method comprising:
receiving, from a base station, a channel state information (CSI) report configuration that configures the UE to transmit a first CSI report associated with a first CSI reference signal (CSI-RS) that is implicitly triggered by a downlink control signal, a second CSI report associated with a second CSI-RS, or a third CSI report associated with a downlink data signal;
determining that the first CSI report associated with the first CSI-RS that is implicitly triggered by the downlink control signal is scheduled to be transmitted on a same uplink resource as one or more of the second CSI report associated with the second CSI-RS or the third CSI report associated with the downlink data signal; and
transmitting a plurality of the first CSI report, the second CSI report or the third CSI report multiplexed on the same uplink resource based on a report prioritization.

35. The method of claim 34, further comprising receiving a medium access control (MAC) control element (MAC-CE) comprising a command that activates a measurement window having a predetermined length that corresponds to when the UE expects to receive the first CSI-RS after receiving the downlink control signal, wherein the predetermined length of the measurement window is configured via a radio resource control (RRC) configuration or the MAC-CE.

36. The method of claim 35, wherein the measurement window having the predetermined length is activated via a first MAC-CE and deactivated via a second MAC-CE.

37. The method of claim 34, further comprising receiving a radio resource control (RRC) configuration that configures one or more of uplink resources, the first CSI-RS, a first time measurement between the second CSI-RS and the downlink control signal, a second time measurement between the second CSI-RS and a transmission of at least one of the plurality of the first CSI report, the second CSI report or the third CSI report, or a third time measurement between the downlink control signal and the transmission of the at least one of the plurality of the first CSI report, the second CSI report or the third CSI report.

38. The method of claim 34, further comprising receiving a downlink grant scheduling the downlink data signal, wherein the downlink data signal comprises a physical downlink shared channel (PDSCH).

39. The method of claim 38, wherein receiving the downlink grant comprises receiving the downlink control signal, wherein the downlink control signal comprises a downlink control information (DCI) message.

40. An apparatus for wireless communication at a user equipment (UE), the apparatus comprising:
means for receiving, from a base station, a channel state information (CSI) report configuration that configures the UE to transmit a first CSI report associated with a first CSI reference signal (CSI-RS) that is implicitly triggered by a downlink control signal, a second CSI report associated with a second CSI-RS, or a third CSI report associated with a downlink data signal;
means for determining that the first CSI report associated with the first CSI-RS that is implicitly triggered by the downlink control signal is scheduled to be transmitted on a same uplink resource as one or more of the second CSI report associated with the second CSI-RS or the third CSI report associated with the downlink data signal; and
means for transmitting a plurality of the first CSI report, the second CSI report or the third CSI report multiplexed on the same uplink resource based on a report prioritization.

41. The apparatus of claim 40, wherein the CSI report configuration indicates that the UE is configured to transmit both the first CSI report based on the first CSI-RS implicitly triggered by the downlink control signal and the second CSI report based on the second CSI-RS on the same uplink resource.

42. The apparatus of claim 41, further comprising means for prioritizing between the first CSI report associated with the first CSI-RS and the second CSI report associated with the second CSI-RS based on corresponding report configuration identifiers.

43. The apparatus of claim 40, further comprising means for monitoring for a particular CSI report trigger event to occur by determining whether the CSI report configuration indicates that a first report configuration identifier associated with the first CSI-RS implicitly triggered by the downlink control signal and a second report configuration identifier associated with the second CSI-RS are scheduled to use same uplink resources, wherein the second CSI-RS corresponds to one of an aperiodic CSI-RS, a periodic CSI-RS or a semi-persistent CSI-RS.

44. A non-transitory computer-readable medium storing computer executable code, the code when executed by at least one processor, causes the at least one processor to:
receive, from a base station, a channel state information (CSI) report configuration that configures a user equipment (UE) to transmit a first CSI report associated with a first CSI reference signal (CSI-RS) that is implicitly triggered by a downlink control signal, a second CSI report associated with a second CSI-RS, or a third CSI report associated with a downlink data signal;
determine that the first CSI report associated with the first CSI-RS that is implicitly triggered by the downlink control signal is scheduled to be transmitted on a same uplink resource as one or more of the second CSI report associated with the second CSI-RS or the third CSI report associated with the downlink data signal; and
transmit a plurality of the first CSI report, the second CSI report or the third CSI report multiplexed on the same uplink resource based on a report prioritization.

45. The non-transitory computer-readable medium of claim 44, wherein the code, which when executed by the at least one processor, further cause the at least one processor to receive a medium access control (MAC) control element (MAC-CE) comprising a command that activates a measurement window having a predetermined length that corresponds to when the UE expects to receive the first CSI-RS after receiving the downlink control signal, wherein the predetermined length of the measurement window is configured via a radio resource control (RRC) configuration or the MAC-CE.

46. The non-transitory computer-readable medium of claim 45, wherein the measurement window having the predetermined length is activated via a first MAC-CE and deactivated via a second MAC-CE.

47. The non-transitory computer-readable medium of claim 44, wherein the code, which when executed by the at least one processor, further cause the at least one processor to receive a radio resource control (RRC) configuration that configures one or more of uplink resources, the first CSI-RS, a first time measurement between the second CSI-RS and the downlink control signal, a second time measurement between the second CSI-RS and a transmission of at least one of the plurality of the first CSI report, the second CSI report or the third CSI report, or a third time measurement between the downlink control signal and the transmission of the at least one of the plurality of the first CSI report, the second CSI report or the third CSI report.

48. The non-transitory computer-readable medium of claim 44, wherein the code, which when executed by the at least one processor, further cause the at least one processor to receive a downlink grant scheduling the downlink data signal, wherein the downlink data signal comprises a physical downlink shared channel (PDSCH).

49. The non-transitory computer-readable medium of claim 48, wherein the code causing the at least one processor to receive the downlink grant further causes the at least one processor to receive the downlink control signal, wherein the downlink control signal comprises a downlink control information (DCI) message.
